(19) United States
(12) Patent Application Publication
(10) Pub. No.: US 2026/0176384 A1
(43) Pub. Date: Jun. 25, 2026

(54) OLEFIN POLYMERIZATION CATALYST AND METHOD FOR PRODUCING OLEFIN POLYMER

(71) Applicant: TOHO TITANIUM CO., LTD., Chigasaki-shi (JP)

(72) Inventors: Christopher Garland Bauch, Chigasaki-shi (JP); Teppei Ishikawa, Chigasaki-shi (JP)

(73) Assignee: TOHO TITANIUM CO., LTD., Chigasaki-shi (JP)

(21) Appl. No.: 18/987,141

(22) Filed: Dec. 19, 2024

(51) Int. Cl. C08F 4/14; C08F 210/06

(52) U.S. Cl. CPC C08F 4/14; C08F 210/06

(57) ABSTRACT

Provided is an olefin polymerization catalyst characterized in that the catalyst includes (I) a solid catalyst component for olefin polymerization containing at least magnesium, titanium, halogen and an internal electron-donating compound, (II) an organoaluminum compound, and (III) an external electron-donating compound, wherein in the olefin polymerization catalyst, there exist, as the internal electron-donating compound, at least one or more compounds selected from a first internal electron-donating compound and one or more compounds selected from a second internal electron-donating compound, and as the external electron-donating compound, there exists at least one or more compounds selected from an alkoxysilane compound and an aminoalkoxysilane compound. According to the present invention, an olefin polymerization catalyst that is able to produce an olefin polymer having a high melt flowability with a small use amount of hydrogen and a high flexural modulus and a method for producing an olefin polymer using the catalyst can be provided.

### TECHNICAL FIELD

The present invention relates to an olefin polymerization catalyst and to a method for producing an olefin polymer using the catalyst.

### BACKGROUND ART

In recent years, olefin polymers such as polypropylene (PP) have been used for various applications such as containers and film, as well as for molded articles such as automotive parts and home appliances.

Polypropylene resin compositions are used in many fields as one of the most important plastic materials because of its light weight, excellent moldability, excellent chemical stability such as heat resistance and chemical resistance as molded article, and very good cost performance. In the field of automotive parts and the like, polypropylene having a high flexural modulus is desired in order to reduce its thickness and weight.

Traditionally, for the production of an olefin polymer such as polypropylene with a high flexural modulus, the olefin has been polymerized using an olefin polymerization catalyst containing 2,3-diisopropylsuccinate diester as an internal electron donor.

For example, in Patent Literature Example 1, it is described that propylene was polymerized using 2,3-diisopropylsuccinate ethyl ester as the internal electron donor.

### CITATION LIST

### Patent Literature

Patent Literature 1: Japanese Patent Publication No. 2013-533367

### SUMMARY OF INVENTION

### Technical Problem

However, when polymerization of an olefin is carried out by using an olefin polymerization catalyst containing, as a solid catalyst component, a solid catalyst component for olefin polymerization containing diethyl succinate as an internal electron-donating compound, the resulting polymer has a high flexural modulus, but the melt flowability thereof decreases. Therefore, to obtain a polymer having a practical melt flowability using the succinate diester compound as the internal electron-donating compound, the amount of hydrogen used during polymerization needs to be increased.

Therefore, an object of the present invention is to provide an olefin polymerization catalyst and a method for producing an olefin polymer using the catalyst that is able to produce an olefin polymer having a high melt flowability with the use of a small amount of hydrogen and a high flexural modulus.

### Solution to Problem

In order to solve the above technical problem, the inventors of the present invention have carried out an extensive investigation; as a result it has been found that when as the internal electron-donating compound in the solid catalyst component for olefin polymerization that constitutes the olefin polymerization catalyst, a succinate diester compound and one or more compounds selected from internal electron-donating compounds other than the succinate diester compound are simultaneously used in combination with an alkoxysilane compound represented by the general formula (1) and an aminoalkoxysilane compound represented by the general formula (2) as external electron-donating compounds in the solid catalyst component for olefin polymerization, a sufficient melt flowability can be obtained even when the amount of hydrogen used during polymerization is small. On the basis of this finding, the present invention has been completed.

In other words, the present invention provides the following:
(1) an olefin polymerization catalyst including:
   (I) a solid catalyst component for olefin polymerization containing at least magnesium, titanium, halogen, and an internal electron-donating compound;
   (II) an organoaluminum compound; and
   (III) an external electron-donating compound,
      wherein
      in the olefin polymerization catalyst, there exist, as the internal electron-donating compound, a first internal electron-donating compound and a second internal electron-donating compound; the first internal electron-donating compound being one or more compounds selected from a succinate diester compound, and the second internal electron-donating compound being one or more compounds selected from an internal electron-donating compound other than the succinate diester compound; and further includes as the external electron-donating compound at least one or more compounds selected from alkoxysilane compounds represented by the following general formula (1):

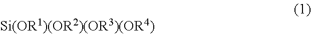

(in the formula, R¹, R², R³, and R⁴, all of which are optionally identical or different from each other, represent a linear alkyl group having the carbon number of 1 to 8, or a branched alkyl group having the carbon number of 3 to 8), and one or more compounds selected from aminoalkoxysilane compounds represented by the following general formula (2):

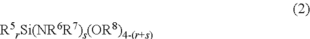

(in the formula, r is 0 to 2, s is 1 to 3, and r+s is 1 to 3. R⁵, which optionally contains a heteroatom, represents any group selected from a linear or a branched alkyl group having the carbon number of 1 to 12, a substituted or an unsubstituted cycloalkyl group, a phenyl group, an allyl group, and an aralkyl group. R⁶ and R⁷, which are optionally identical or different from each other and optionally contain a heteroatom, represent a hydrogen atom or any group selected from a linear or a branched alkyl group having the carbon number of 1 to 12, a substituted or an unsubstituted cycloalkyl group, a phenyl group, an allyl group, and an aralkyl group. R⁶ and R⁷ are optionally combined to form a ring shape, and R⁶ and R⁷ are optionally identical or different from each other. R⁸, which optionally contains a heteroatom, represents any group selected from an alkyl group having the carbon number of 1 to 12, a cycloalkyl group, a phenyl group, a vinyl group, an allyl group, and an aralkyl group. When R⁸ is plural, they are optionally identical or different from each other);
(2) the olefin polymerization catalyst according to (1) including: as (I) the solid catalyst component for olefin polymerization, (a1) a first internal electron-donating compound-containing solid catalyst component for olefin polymerization containing magnesium, titanium, halogen, and the first internal electron-donating compound as the internal electron-donating compound and (a2) a second internal electron-donating compound-containing solid catalyst component for olefin polymerization containing magnesium, titanium, halogen, and the second internal electron-donating compound as the internal electron-donating compound; and
   as (III) the external electron-donating compound, the alkoxysilane compound represented by the general formula (1) and the aminoalkoxysilane compound represented by the general formula (2);
(3) the olefin polymerization catalyst according to (1) including: as (I) the solid catalyst component for olefin polymerization, (b) a first internal electron-donating compound- and a second internal electron-donating compound-containing solid catalyst component for olefin polymerization containing magnesium, titanium, halogen, and as the internal electron-donating compound, the first internal electron-donating compound and the second internal electron-donating compound, and
   as (III) the external electron-donating compound, the alkoxysilane compound represented by the general formula (1) and the aminoalkoxysilane compound represented by the general formula (2);
(4) the olefin polymerization catalyst according to (1), in which the alkoxysilane compound represented by the general formula (1) is at least one selected from the group consisting of tetramethoxysilane, tetraethoxysilane, tetra(n-propoxy)silane, tetraisopropoxysilane, tetra(n-butoxy)silane, tetraisobutoxysilane, and tetrakis(2-ethylhexyloxy)silane;
(5) the olefin polymerization catalyst according to (1), in which the aminoalkoxysilane compound represented by the general formula (2) is at least one selected from the group consisting of dimethylaminotriethoxysilane, diethylaminotrimethoxysilane, diethylaminotriethoxysilane, diethylaminotri-n-propoxysilane, di-n-propylaminotriethoxysilane, methyl-n-propylaminotriethoxysilane, methyl-t-butylaminotriethoxysilane, ethyl-n-propylaminotriethoxysilane, ethylisopropylaminotriethoxysilane, and methylethylaminotriethoxysilane;
(6) the olefin polymerization catalyst according to (1), in which a molar ratio (Y/X) of a mole content (Y) of the aminoalkoxysilane compound represented by the general formula (2) to a mole content (X) of the alkoxysilane compound represented by the general formula (1) is from 1/99 to 70/30; and
(7) a method for producing an olefin polymer, the method including polymerizing an olefin using the olefin polymerization catalyst according to (1).

### Advantageous Effect of Invention

According to the present invention, an olefin polymerization catalyst that is able to produce an olefin polymer having a high melt flowability with a small use amount of hydrogen and a high flexural modulus and a method for producing an olefin polymer using the catalyst can be provided.

### DESCRIPTION OF EMBODIMENTS

The olefin polymerization catalyst according to the present invention includes:
(I) a solid catalyst component for olefin polymerization containing at least magnesium, titanium, halogen, and an internal electron-donating compound,
(II) an organoaluminum compound; and
(III) an external electron-donating compound,
   wherein
in the olefin polymerization catalyst, there exist, as the internal electron-donating compound, a first internal electron-donating compound and a second internal electron-donating compound; the first internal electron-donating compound being one or more compounds selected from a succinate diester compound, and the second internal electron-donating compound being one or more compounds selected from an internal electron-donating compound other than the succinate diester compound; and further includes as the external electron-donating compound at least one or more compounds selected from alkoxysilane compounds represented by the following general formula (1):

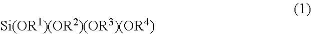

(in the formula, R¹, R², R³, and R⁴, all of which are optionally identical or different from each other, represent a linear alkyl group having the carbon number of 1 to 8, or a branched alkyl group having the carbon number of 3 to 8), and one or more compounds selected from aminoalkoxysilane compounds represented by the following general formula (2):

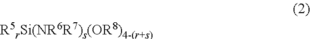

(in the formula, r is 0 to 2, s is 1 to 3, and r+s is 1 to 3. R⁵, which optionally contains a heteroatom, represents any group selected from a linear or a branched alkyl group having the carbon number of 1 to 12, a substituted or an unsubstituted cycloalkyl group, a phenyl group, an allyl group, and an aralkyl group. R⁶ and R⁷, which are optionally identical or different from each other and optionally contain a heteroatom, represent a hydrogen atom or any group selected from a linear or a branched alkyl group having the carbon number of 1 to 12, a substituted or an unsubstituted cycloalkyl group, a phenyl group, an allyl group, and an aralkyl group. R⁶ and R⁷ are optionally combined to form a ring shape, and R⁶ and R⁷ are optionally identical or different from each other. R⁸, which optionally contains a heteroatom, represents any group selected from an alkyl group having the carbon number of 1 to 12, a cycloalkyl group, a phenyl group, a vinyl group, an allyl group, and an aralkyl group. when R⁸ is plural, they are optionally identical or different from each other).

In the olefin polymerization catalyst according to the present invention, there are the embodiment in which the catalyst includes (I) as a solid catalyst component for olefin polymerization, (a1) a first internal electron-donating compound-containing olefin polymerization catalyst component that contains a first internal electron-donating compound and (a2) a second internal electron-donating compound-containing olefin polymerization catalyst component that contains a second internal electron-donating compound, and the embodiment in which the catalyst includes (b) a first internal electron-donating compound- and a second internal electron-donating compound-containing solid catalyst component for olefin polymerization that contains the first internal electron-donating compound and the second internal electron-donating compound.

In other words, the olefin polymerization catalyst according to the first embodiment of the present invention includes:
(I) as a solid catalyst component for olefin polymerization containing at least magnesium, titanium, halogen, and an internal electron-donating compound, at least (a1) a first internal electron-donating compound-containing solid catalyst component for olefin polymerization and (a2) a second internal electron-donating compound-containing solid catalyst component for olefin polymerization;
(II) an organoaluminum compound; and
(III) as an external electron-donating compound, at least an alkoxysilane compound represented by the general formula (1) and an aminoalkoxysilane compound represented by the general formula (2).

The olefin polymerization catalyst according to the second embodiment of the present invention includes:
(I) as a solid catalyst component for olefin polymerization containing at least magnesium, titanium, halogen, and an internal electron-donating compound, at least (b) a first and second internal electron-donating compound-containing solid catalyst component for olefin polymerization;
(II) an organoaluminum compound; and
(III) as an external electron-donating compound, at least an alkoxysilane compound represented by the general formula (1) and an aminoalkoxysilane compound represented by the general formula (2).

The olefin polymerization catalyst according to the first embodiment of the present invention includes as (I) the solid catalyst component for olefin polymerization, at least (a1) the first internal electron-donating compound-containing solid catalyst component for olefin polymerization and (a2) the second internal electron-donating compound-containing solid catalyst component for olefin polymerization.

(a1) The first internal electron-donating compound-containing solid catalyst component for olefin polymerization that is related to the olefin polymerization catalyst according to the first embodiment of the present invention is the solid catalyst component for olefin polymerization containing at least magnesium, titanium, halogen, and as the internal electron-donating compound, the first internal electron-donating compound, in which the first internal electron-donating compound is one or more compounds selected from a succinate diester compound.

(a1) The first internal electron-donating compound-containing solid catalyst component for olefin polymerization may include a contact-reaction product obtained by the reaction in which a raw material component as the source of magnesium, a raw material component as the source of titanium and halogen, and the first internal electron-donating compound, which is the internal electron-donating compound, are brought into mutual contact in an organic solvent. Specifically, this may include a contact-reaction product in which as the raw material components, a dialkoxymagnesium is used as the source of magnesium and a tetravalent titanium halide compound is used as the source of titanium and halogen, and then, these are brought into mutual contact with the internal electron-donating compound including the first internal electron-donating compound.

In (a1) the first internal electron-donating compound-containing solid catalyst component for olefin polymerization, (a2) the second internal electron-donating compound-containing solid catalyst component for olefin polymerization, which will be described later, and (b) the first and second internal electron-donating compound-containing olefin polymerization catalyst components, the dialkoxymagnesium, which is the raw material component as the source of magnesium, may include one or more compounds selected from a magnesium dihalide, a dialkylmagnesium, an alkylmagnesium halide, a dialkoxymagnesium, a diaryloxymagnesium, an alkoxymagnesium halide, a magnesium fatty acid, and the like. Among these magnesium compounds, a magnesium dihalide, a mixture of a magnesium dihalide and a dialkoxymagnesium, and a dialkoxymagnesium are preferable; a dialkoxymagnesium is especially preferable.

Illustrative examples of the dialkoxymagnesium may include dimethoxymagnesium, diethoxymagnesium, dipropoxymagnesium, dibutoxymagnesium, ethoxymethoxymagnesium, ethoxypropoxymagnesium, and butoxyethoxymagnesium. These dialkoxymagnesiums may also be the one that is obtained by reacting a metallic magnesium with an alcohol in the presence of a halogen or a halogen-containing metal compound. The dialkoxymagnesium may be used singly or in a combination of those described above.

The dialkoxymagnesium is preferably in a granular form or in a powder form; its shape may be irregular or spherical.

When the dialkoxymagnesium having a spherical shape is used, a polymer powder having a better particle shape (more spherical) and a narrow particle size distribution may be obtained, so that the handling operability of the resulting polymer powder during the polymerization operation is improved; thus, for example, the occurrence of blockage caused by fine powders in the produced polymer powder can be suppressed.

The spherical dialkoxymagnesium is not necessarily be true spherical; the spherical dialkoxymagnesium with an oval shape or a potato-like shape can also be used. Specifically, the particle shape thereof in terms of the ratio of the major axis diameter l to the minor axis diameter w (l/w) is 3 or less, preferably from 1 to 2, and more preferably from 1 to 1.5.

The average particle diameter (average particle diameter D50) of the dialkoxymagnesium is preferably from 1.0 to 200.0 μm, and more preferably from 5.0 to 150.0 μm. Here, the average particle diameter D50 means the particle diameter of 50% in terms of the integrated particle size distribution on the volume basis when being measured using a particle size analyzer based on a laser light scattering diffraction method.

When the dialkoxymagnesium is spherical, the average particle diameter D50 thereof is preferably from 1.0 to 100.0 μm, more preferably from 5.0 to 80.0 μm, and still more preferably from 10.0 to 70.0 μm.

As for the particle size distribution of the dialkoxymagnesium, the particle size distribution thereof is preferably narrow with few fine and coarse particles.

Specifically, when measured using a particle size analyzer based on a laser light scattering diffraction method, the content of the dialkoxymagnesium having the particle diameter of 5.0 μm or less is preferably 20% or less, and more preferably 10% or less. On the other hand, when measured using a particle size analyzer based on a laser light scattering diffraction method, the content of the particle having the particle diameter of 100.0 μm or more is preferably 20% or less, and more preferably 10% or less.

Furthermore, when expressed by ln(D90/D10), the particle size distribution thereof is preferably 3 or less, and more preferably 2 or less. Here, D90 means the particle diameter of 90% in terms of the integrated particle size distribution on the volume basis when measured using a particle size analyzer based on a laser light scattering diffraction method. Also, D10 means the particle diameter of 10% in terms of the integrated particle size distribution on the volume basis when measured using a particle size analyzer based on a laser light scattering diffraction method.

Examples of the method for producing the above-mentioned spherical dialkoxymagnesium include Japanese Patent Publication No. S62-51633, Japanese Patent Publication No. H03-74341, Japanese Patent Publication No. H04-368391, and Japanese Patent Publication No. H08-73388.

The specific surface area of the dialkoxymagnesium is preferably 5 m²/g or more, more preferably from 5 to 50 m²/g, and still more preferably from 10 to 40 m²/g.

When the dialkoxymagnesium having the specific surface area within the above range is used, the solid catalyst component for olefin polymerization having an intended specific surface area can be readily prepared.

In this specification, the specific surface area of the dialkoxymagnesium means the value measured by a BET method. Specifically, this means the value measured by the BET method (automatic measurement) in the presence of a mixture of nitrogen and helium gases using Automatic Surface Area Analyzer HM model-1230 (manufactured by Mountech Co., Ltd.) after vacuum drying the sample at 50° C. for 2 hours.

The dialkoxymagnesium is preferably in solution or suspension at the time of reaction, because the reaction can take place suitably in solution or suspension.

When the dialkoxymagnesium is solid, it can be made to a solution thereof by dissolving it in a solvent that can dissolve the dialkoxymagnesium, or it can be made to a suspension in a solvent that cannot dissolve the dialkoxymagnesium.

In the case when the dialkoxymagnesium is a liquid, it may be used as it is as a solution of the dialkoxymagnesium, or it may be further dissolved in a solvent that can dissolve the dialkoxymagnesium; and this may be used as the dialkoxymagnesium solution.

The compound that can dissolve the solid dialkoxymagnesium may include at least one compound selected from the group consisting of an alcohol, an ether, and an ester. Among these, an alcohol such as ethanol, propanol, butanol, and 2-ethylhexanol are preferable, and 2-ethylhexanol is especially preferable.

On the other hand, the medium that cannot dissolve the solid dialkoxymagnesium may include one or more solvents selected from a saturated hydrocarbon solvent and an unsaturated hydrocarbon solvent, which cannot dissolve the dialkoxymagnesium.

In (a1) the first internal electron-donating compound-containing solid catalyst component for olefin polymerization, (a2) the second internal electron-donating compound-containing solid catalyst component for olefin polymerization, which will be described later, and (b) the first and second internal electron-donating compound-containing olefin polymerization catalyst components, there is no particular restriction in the tetravalent titanium halide compound, which is the raw material component as the source of titanium and halogen. However, it is preferable to use one or more compounds selected from the group consisting of a titanium halide and an alkoxytitanium halide represented by the following general formula (3):

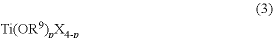

(in the formula, R⁹ represents an alkyl group having the carbon number of 1 to 4; X represents a halogen atom such as a chlorine atom, a bromine atom, and an iodine atom; and p represents the number of 0≤p≤3.).

In the general formula (3), p represents the number of 0≤p≤3; specifically, p is 0, 1, 2, or 3.

The titanium halide represented by the general formula (3) may include one or more compounds selected from titanium tetrachloride, titanium tetrabromide, and titanium tetraiodide.

The alkoxytitanium halide represented by the general formula (3) may include one or more compounds selected from methoxytitanium trichloride, ethoxytitanium trichloride, propoxytitanium trichloride, n-butoxytitanium trichloride, dimethoxytitanium dichloride, diethoxytitanium dichloride, dipropoxytitanium dichloride, di-n-butoxytitanium dichloride, trimethoxytitanium chloride, triethoxytitanium chloride, tripropoxytitanium chloride, and tri-n-butoxytitanium chloride.

As for the tetravalent titanium halide compound, a titanium tetrahalide is preferable; titanium tetrachloride is more preferable.

These titanium compound may be used singly or in a combination of two or more of those described above.

(a1) The first internal electron-donating compound-containing solid catalyst component for olefin polymerization contains the first internal electron-donating compound as the internal electron-donating compound.

The first internal electron-donating compound is one or more compounds selected from a succinate diester compound. The succinate diester compound is, for example, the one having the following general formula (5):

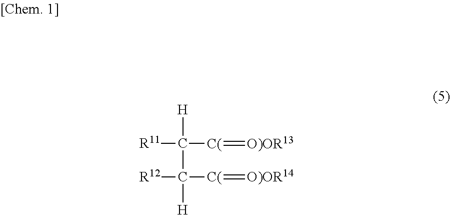

(in the general formula (5), R¹¹ and R¹², which are optionally identical or different from each other, represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group; R¹³ and R^{14′} each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, and an aromatic hydrocarbon group having the carbon number of 6 to 20.)

The presence of the succinate diester compound, which is the first internal electron-donating compound, as the internal electron-donating compound in the olefin polymerization catalyst is desirable because it allows to increase the flexural modulus of the resulting polymer.

In the succinate diester compound represented by the general formula (5), R¹¹ and R¹², which are optionally identical or different from each other, represent an atom or a group selected from a hydrogen atom, a halogen atom, a linear alkyl group having the carbon number of 1 to 12, a branched alkyl group having the carbon number of 3 to 12, a vinyl group, a linear or a branched alkenyl group having the carbon number of 3 to 12, a linear or a branched halogen-substituted alkyl group having the carbon number of 2 to 12, a cycloalkyl group having the carbon number of 3 to 12, a cycloalkenyl group having the carbon number of 3 to 12, an aromatic hydrocarbon group having the carbon number of 6 to 20, a nitrogen-containing group, a phosphorus-containing group, and a silicon-containing group; a linear alkyl group having the carbon number of 1 to 4, a branched alkyl group having the carbon number of 3 to 5, and a nitrogen-containing group are preferable.

When R¹¹ and R¹² are a linear alkyl group having the carbon number of 2 to 4, or a branched alkyl group having the carbon number of 3 to 5, they are specifically an ethyl group, an n-propyl group, an isopropyl group, an n-butyl group, an isobutyl group, an n-pentyl group, an isopentyl group, and a neopentyl group.

When R¹¹ and R¹² are a nitrogen-containing group, they are specifically an amino group and a cyano group.

In the succinate diester compound represented by the general formula (5), R¹³ and R¹⁴ each, which are optionally identical or different from each other, independently represent a linear alkyl group having the carbon number of 1 to 12, a branched alkyl group having the carbon number of 3 to 12, a cycloalkyl group having the carbon number of 3 to 12, a cycloalkenyl group having the carbon number of 3 to 12, and an aromatic hydrocarbon group having the carbon number of 6 to 20; a linear and a branched alkyl group having the carbon number of 1 to 4 are preferable.

When R¹³ and R¹⁴ are an alkyl group having the carbon number of 1 to 4, they are specifically a methyl group, an ethyl group, an n-propyl group, an isopropyl group, an n-butyl group, and an isobutyl group.

There is no particular restriction in the succinate diester compound; thus, it is, for example, one or more compounds selected from:
diethyl succinate, diethyl 2,3-dimethylsuccinate, diethyl 2,3-diethylsuccinate, diethyl 2,3-di-n-propylsuccinate, diethyl 2,3-diisopropylsuccinate, diethyl 2,3-di-n-butylsuccinate, diethyl 2,3-diisobutylsuccinate;
di-n-propyl succinate, di-n-propyl 2,3-dimethylsuccinate, di-n-propyl 2,3-diethylsuccinate, di-n-propyl 2,3-di-n-propylsuccinate, di-n-propyl 2,3-diisopropylsuccinate, di-n-propyl 2,3-di-n-butylsuccinate, di-n-propyl 2,3-diisobutylsuccinate;
diisopropyl succinate, diisopropyl 2,3-dimethylsuccinate, diisopropyl 2,3-diethylsuccinate, diisopropyl 2,3-di-n-propylsuccinate, diisopropyl 2,3-diisopropylsuccinate, diisopropyl 2,3-di-n-butylsuccinate, diisopropyl 2,3-diisobutylsuccinate;
di-n-butyl succinate, di-n-butyl 2,3-dimethylsuccinate, di-n-butyl 2,3-diethylsuccinate, di-n-butyl 2,3-di-n-propylsuccinate, di-n-butyl 2,3-diisopropylsuccinate, di-n-butyl 2,3-di-n-butylsuccinate, di-n-butyl 2,3-diisobutylsuccinate;
diisobutyl succinate, diisobutyl 2,3-dimethylsuccinate, diisobutyl 2,3-diethylsuccinate, diisobutyl 2,3-di-n-propylsuccinate, diisobutyl 2,3-diisopropylsuccinate, diisobutyl 2,3-di-n-butylsuccinate, diisobutyl 2,3-diisobutylsuccinate;
diethyl 2,3-diisopropyl-2-cyanosuccinate, di-n-butyl 2,3-diisopropyl-2-cyanosuccinate, di-n-butyl 2,3-diisopropyl-2-cyanosuccinate, diisobutyl 2,3-diisopropyl-2-cyanosuccinate, diethyl 2,3-dicyclopentyl-2-cyanosuccinate, di-n-butyl 2,3-dicyclopentyl-2-cyanosuccinate, diisobutyl 2,3-dicyclopentyl-2-cyanosuccinate, diethyl 2,3-dicyclohexyl-2-cyanosuccinate, di-n-butyl 2,3-dicyclohexyl-2-cyanosuccinate, diisobutyl 2,3-dicyclohexyl-2-cyanosuccinate, diethyl 2-cyclopentyl-3-cyclohexyl-2-cyanosuccinate, 1-isobutyl 4-ethyl 2,3-diisopropyl-2-cyanosuccinate, 1-n-butyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-isopropyl-3-n-propyl-2-cyanosuccinate, diethyl 2-isopropyl-3-butyl-2-cyanosuccinate, diethyl 2-isopropyl-3-phenyl-2-cyanosuccinate, diethyl 2-cyclohexyl-3-isopropyl-2-cyanosuccinate, and 1-ethyl 4-isobutyl 2-isopropyl-3-phenyl-2-cyanosuccinate.

Among these, preferably used succinate diester compounds are diethyl succinate, di-n-propyl succinate, di-n-butyl succinate, diisobutyl succinate, diethyl 2,3-di-n-propylsuccinate, diethyl 2,3-diisopropylsuccinate, di-n-propyl 2,3-di-n-propylsuccinate, di-n-propyl 2,3-diisopropylsuccinate, diisopropyl 2,3-di-n-propylsuccinate, diisopropyl 2,3-diisopropylsuccinate, di-n-butyl 2,3-di-n-propylsuccinate, di-n-butyl 2,3-diisopropylsuccinate, diisobutyl 2,3-di-n-propylsuccinate, diisobutyl 2,3-diisopropylsuccinate, diethyl 2,3-diisopropyl-2-cyanosuccinate, 1-isobutyl 4-ethyl 2,3-diisopropyl-2-cyanosuccinate, diethyl 2-isopropyl-3-methyl-2-cyanosuccinate, diethyl 2-isopropyl-3-ethyl-2-cyanosuccinate, diethyl 2-cyclopentyl-3-isopropyl-2-cyanosuccinate, and di-n-butyl 2,3-diisopropyl-2-cyanosuccinate.

The succinate diester compound may be used singly or in a combination of two or more of those compounds described above.

(a1) The first internal electron-donating compound-containing solid catalyst component for olefin polymerization contains as an essential component the first internal electron-donating compound as the internal electron-donating compound. The component, however, may further contain as the internal electron-donating compound an internal electron-donating compound other than the first internal electron-donating compound (hereinafter, this is referred to as “other internal electron-donating compound”, as appropriate).

Such other internal electron-donating compound may include one or more compounds selected from a carbonate, an acid halide, an acid amide, a nitrile, an acid anhydride, and a carboxylate ester.

Such other internal electron-donating compound may include specifically one or more compounds selected from an ether carbonate compound, as well as carboxylate diesters such as a cycloalkane dicarboxylate diester, a cycloalkene dicarboxylate diester, an alkyl-substituted malonate diester, and a maleate diester.

More specifically, more preferable are one or more compounds selected from an ether carbonate compound such as (2-ethoxyethyl) methyl carbonate, (2-ethoxyethyl) ethyl carbonate, and (2-ethoxyethyl) phenyl carbonate, as well as a cycloalkane dicarboxylate diester such as dimethyl cyclohexane-1,2-dicarboxylate.

In (a1) the first internal electron-donating compound-containing solid catalyst component for olefin polymerization, the content of the first internal electron-donating compound in the total content of the component in terms of the solid content is from 8.0 to 24.0% by mass, preferably from 12.0 to 22.0% by mass, and more preferably from 14.0 to 20.0% by mass. When the content of the first internal electron-donating compound in the total content of the component in terms of the solid content is within the above-mentioned range, the molecular weight distribution of the olefin polymer can be made wide in the olefin polymerization, resulting in a higher flexural modulus. On the other hand, when the content of first internal electron-donating compound in the total content of the component in terms of the solid content is below the above-mentioned range, the molecular weight distribution is not sufficiently wide, and when it is above the range, the polymerization activity is low.

In (a1) the first internal electron-donating compound-containing solid catalyst component for olefin polymerization, the content of the titanium atom in the total content of the component in terms of the solid content is from 1.0 to 6.0% by mass, preferably from 1.5 to 5.0% by mass, and more preferably from 2.0 to 4.5% by mass.

In (a1) the first internal electron-donating compound-containing solid catalyst component for olefin polymerization, the content of the halogen atom in the total content of the component in terms of the solid content is from 50.0 to 70.0% by mass, preferably from 55.0 to 68.0% by mass, and more preferably from 58.0 to 67.0% by mass.

In (a1) the first internal electron-donating compound-containing solid catalyst component for olefin polymerization, the content of the magnesium atom in the total content of the component in terms of the solid content is from 15.0 to 25.0% by mass, preferably from 16.0 to 23.0% by mass, and more preferably from 16.0 to 22.0% by mass.

(a1) The first internal electron-donating compound-containing solid catalyst component for olefin polymerization is preferably the one that is prepared by contacting the dialkoxymagnesium, the titanium halide compound, and the first internal electron-donating compound as described above in the presence of an inert organic solvent.

In the present invention, the above-mentioned inert organic solvent is preferably the one that can dissolve the titanium halide compound but not the dialkoxymagnesium; specifically, the inert organic solvent includes one or more solvents selected from: saturated hydrocarbon compounds such as pentane, hexane, heptane, octane, nonane, decane, cyclohexane, methylcyclohexane, ethylcyclohexane, 1,2-diethylcyclohexane, methylcyclohexene, decalin, and mineral oil; aromatic hydrocarbon compounds such as benzene, toluene, xylene, and ethylbenzene; and halogenated hydrocarbon compounds such as ortho-dichlorobenzene, methylene chloride, 1,2-dichlorobenzene, carbon tetrachloride, and dichloroethane.

As for the inert organic solvent, a saturated hydrocarbon compound or an aromatic hydrocarbon compound that are in a liquid state at room temperature with a boiling point range of about 50 to 200° C. is preferably used. Among these, one or more solvents selected from hexane, heptane, octane, ethylcyclohexane, mineral oil, toluene, xylene, and ethylbenzene are preferable, and one or more solvents selected from hexane, heptane, ethylcyclohexane, and toluene are especially preferable.

In this specification, the content of titanium in the solid catalyst component for olefin polymerization means the value measured the method (redox titration) in accordance with JIS 8311-1997 “Method for determination of titanium in titanium ores”.

In this specification, the content of magnesium in the solid catalyst component for olefin polymerization means the value measured by the EDTA titration method, in which the solid catalyst component for olefin polymerization is dissolved in hydrochloric acid solution and titrated with an EDTA solution.

In this specification, the halogen content in the solid catalyst component for olefin polymerization means the value measured by the silver nitrate titration method, in which the solid catalyst component is treated with a mixed solution of sulfuric acid and pure water to make an aqueous solution, and then a predetermined amount of the resulting mixture is separated and titrated with a silver nitrate standard solution to determine the halogen content.

In this specification, the content of the succinate diester compound in the solid catalyst component for olefin polymerization and of other internal electron-donating compound added as needed means the value obtained by hydrolyzing the solid catalyst component for olefin polymerization, extracting the succinate diester compound and other internal electron-donating compound added as needed using an aromatic solvent, and measuring the solution by a gas chromatography Flame Ionization Detector (FID) method.

(a1) The first internal electron-donating compound-containing solid catalyst component for olefin polymerization may be suitably produced by the production method of (a1) the first internal electron-donating compound-containing solid catalyst component for olefin polymerization, as described hereunder.

Then, the production method of (a1) the first internal electron-donating compound-containing solid catalyst component for olefin polymerization will be described.

An example of the method for producing (a1) the first internal electron-donating compound-containing solid catalyst component for olefin polymerization may include a method for obtaining (a1) the first internal electron-donating compound-containing solid catalyst component for olefin polymerization, in which the raw material component as the source of magnesium, the raw material component as the source of titanium and halogen, and the first internal electron-containing compound, which is the internal electron-donating compound, are brought into mutual contact in an organic solvent to cause the reaction. Specifically, the method thereof may include a method in which a dialkoxymagnesium, which is the raw material component as the source of magnesium, a tetravalent titanium halide compound, which is the raw material component as the source of titanium and halogen, and the internal electron-donating compound including the first internal electron-donating compound are brought into mutual contact to obtain (a1) the first internal electron-donating compound-containing solid catalyst component for olefin polymerization.

It is preferable that the mutual contact of each component is carried out with stirring in a vessel equipped with a stirrer in an inert gas atmosphere in which a moisture and other materials are removed.

Regarding the temperature at which the above components are brought into contact, in the case that the components are merely brought into contact and stirred and mixed, or dispersed or suspended for denaturation treatment, there is no particular problem when these components are brought into mutual contact around room temperature; and, a relatively low temperature range of −20 to 30° C. is preferable. In the case that a solid product is obtained by reacting at a high temperature during mutual contact of these components, a relatively high temperature range of 40 to 130° C. is preferable. When the temperature during the reaction is less than 40° C., the reaction does not proceed sufficiently well, resulting in an inadequate performance of the solid catalyst component thus obtained, and when the temperature is more than 130° C., evaporation of the solvent used takes place more eminently, making the reaction difficult to be controlled properly.

The reaction time after the mutual contact is preferably 1 minute or longer, more preferably 10 minutes or longer, and still more preferably 30 minutes or longer.

Hereunder, more specific examples of the order in which each component is contacted in the production of (a1) the first internal electron-donating compound-containing solid catalyst component for olefin polymerization will be described.
(1) Magnesium compound→internal electron-donating compound→inert organic solvent→tetravalent titanium halide compound→<<intermediate washing→inert organic solvent→tetravalent halide compound→final washing
(2) Magnesium compound→inert organic solvent→internal electron-donating compound→tetravalent halide compound→<<intermediate washing→inert organic solvent→tetravalent titanium halide compound>>→final washing
(3) Magnesium compound→tetravalent halide compound→inert organic solvent→internal electron-donating compound→<<intermediate washing→inert organic solvent→internal electron-donating compound→tetravalent titanium halide compound>>→final washing
(4) Magnesium compound→tetravalent titanium halide compound→inert organic solvent→internal electron-donating compound→<<intermediate washing→inert organic solvent→tetravalent titanium halide compound→internal electron-donating compound>>→final washing
(5) Magnesium compound→tetravalent halide compound→inert organic solvent→internal electron-donating compound→<<intermediate washing→inert organic solvent→internal electron-donating compound→tetravalent titanium halide compound>>→final washing
(6) Magnesium compound→inert organic solvent→tetravalent titanium halide compound→internal electron-donating compound→<<intermediate washing→inert organic solvent→tetravalent titanium halide compound→internal electron-donating compound>>→final washing
(7) Magnesium compound→inert organic solvent→internal electron-donating compound→tetravalent titanium halide compound→<<intermediate washing→internal electron-donating compound→inert organic solvent→tetravalent titanium halide compound>>→final washing
(8) Magnesium compound→inert organic solvent→internal electron-donating compound→tetravalent titanium halide compound→<<intermediate washing→internal electron-donating compound→inert organic solvent→tetravalent titanium halide compound>>→final washing.

In the above contact examples (1) through (8), “→” means the order of contact. For example, “magnesium compound→internal electron-donating compound” means that the magnesium compound and the internal electron-donating compound are contacted in this order.

In the above contact examples (1) through (8), the processes in the double brackets (<< >>) mean that the processes in the double brackets are repeated multiple times as needed, in which the repeating of the processes in the double brackets further enhances the activity. The tetravalent halide compound and the inert organic solvent used in the process in the double brackets may be newly added or may be the residues from the previous processes. When the tetravalent titanium halide compound is added, the tetravalent titanium halide compound used in the process in the double brackets may be newly added or may be the residual tetravalent halide compound from the previous process.

In the above contact examples (1) through (8), it is preferable to use a liquid hydrocarbon compound at room temperature for the intermediate washing, the final washing, and so forth. It is preferable to wash the product obtained at each contact stage in the process other than the intermediate and final washing processes described in the above contact examples (1) through (8).

An especially preferable preparation method for producing (a1) the first internal electron-donating compound-containing solid catalyst component for olefin polymerization may include the methods described in (2), (4), (6), and the like. Namely, the procedure thereof includes suspending a dialkoxymagnesium, i.e., the magnesium compound, in the inert organic solvent such as toluene, heptane, or cyclohexane, and then adding titanium tetrachloride, i.e., the tetravalent titanium halide compound, to the resulting suspension, followed by contacting at least one first internal electron-donating compound, i.e., the internal electron-donating compound, in the suspension at the temperature range of −20 to 130° C. before or after contacting with the tetravalent titanium halide compound in the above-mentioned suspension. In this case, it is preferable to perform the ripening reaction at a low temperature before or after contacting the internal electron-donating compound with the suspension.

After washing (pre-washing), as needed, the solid product obtained in this way with a liquid hydrocarbon compound at room temperature, this is caused to contact with the tetravalent titanium halide compound in the presence of the hydrocarbon compound; then, the intended solid catalyst component for olefin polymerization may be obtained by conducting the reaction treatment at 40 to 130° C., which is then followed by washing (post-washing) of the resulting reaction product with a liquid hydrocarbon compound at room temperature. The above pre-washing and reaction of the resulting pre-washed product with the tetravalent titanium halide compound may be repeated multiple times.

Preferable conditions for the above treatment or washing are as follows.

<Conditions for the Ripening Reaction at Low Temperature Before or after Contact with the Internal Electron-Donating Compound>

The temperature for the low temperature ripening is preferably from −20 to 70° C., more preferably from −10 to 50° C., and still more preferably from −5 to 30° C. The time for the low temperature ripening is preferably from 1 minute to 6 hours, more preferably from 5 minutes to 4 hours, and still more preferably from 10 minutes to 3 hours.

### <Reaction Conditions at the Process Before Intermediate Washing>

The temperature of the reaction among the magnesium compound, the internal electron-donating compound, and the tetravalent titanium halide compound in the inert organic solvent at the process before the intermediate washing is preferably from 0 to 130° C., more preferably from 40 to 120° C., and still more preferably from 50 to 115° C. The reaction time thereof is preferably from 0.5 to 6 hours, more preferably from 0.5 to 5 hours, and still more preferably from 1 to 4 hours.

### <Washing Conditions in the Intermediate Washing and the Final Washing>

The washing temperature is preferably from 0 to 110° C., more preferably from 30 to 100° C., and still more preferably from 30 to 90° C. The repeat number of the washing is preferably from 1 to 20 times, more preferably from 1 to 15 times, and still more preferably from 1 to 10 times.

The hydrocarbon compound that is liquid at room temperature used in the intermediate washing and the final washing is preferably an aromatic hydrocarbon compound or a saturated hydrocarbon compound that is liquid at room temperature (20° C.); so specifically, this is preferably an aromatic hydrocarbon compound such as toluene, xylene, and ethylbenzene, as well as a saturated hydrocarbon compound such as hexane, heptane, cyclohexane, and methylcyclohexane. It is preferable that an aromatic hydrocarbon compound is used in the intermediate washing, and that a saturated hydrocarbon compound is used in the final washing.

The ratio of the amount of each component to be used in the production of (a1) the first internal electron-donating compound-containing solid catalyst component for olefin polymerization varies depending on the preparation method, so that this may not be generally specified. For example, to 1 mole of the magnesium compound, the ratio of the first internal electron-donating compound is preferably from 0.01 to 10 moles, more preferably from 0.01 to 1 mole, and still more preferably from 0.02 to 0.6 moles; the ratio of the tetravalent titanium halide compound is preferably from 0.5 to 100 moles, more preferably from 0.5 to 50 moles, and still preferably from 1 to 10 moles; and the ratio of the inert organic solvent is preferably from 0.001 to 500 moles, more preferably from 0.001 to 100 moles, and especially preferably from 0.005 to 10 moles.

In the preparation method described above, in addition to the first internal electron-donating compound, other internal electron-donating compound may be used simultaneously with this compound. Further, the afore-mentioned contact may be conducted in the presence of other reaction reagent such as silicon, phosphorus, aluminum, as well as a surfactant.

In the production method of (a1) the first internal electron-donating compound-containing solid catalyst component for olefin polymerization, a suitable embodiment of (a1) the first internal electron-donating compound-containing solid catalyst component for olefin polymerization to be obtained has already been explained in detail in the description of (a1) the first internal electron-donating compound-containing solid catalyst component for olefin polymerization.

(a2) The second internal electron-donating compound-containing solid catalyst component for olefin polymerization that is related to the olefin polymerization catalyst according to the first embodiment of the present invention is the solid catalyst component for olefin polymerization containing at least magnesium, titanium, halogen, and as the internal electron-donating compound, the second internal electron-donating compound.

(a2) The second internal electron-donating compound-containing solid catalyst component for olefin polymerization may include a contact-reaction product obtained by the reaction in which a raw material component as the source of magnesium, a raw material component as the source of titanium and halogen, and the second internal electron-donating compound, which is the internal electron-donating compound, are brought into mutual contact in an organic solvent. Specifically, the solid catalyst component may include a contact-reaction product in which as the raw material components, a dialkoxymagnesium is used as the source of magnesium and a tetravalent titanium halide compound is used as the source of titanium and halogen, and then, these are brought into mutual contact with the internal electron-donating compound including the second internal electron-donating compound.

In (a2) the second internal electron-donating compound-containing solid catalyst component for olefin polymerization, the dialkoxymagnesium, i.e., the raw material component as the source of magnesium, is the same as the dialkoxymagnesium, which is the raw material component as the source of magnesium in (a1) the first internal electron-donating compound-containing solid catalyst component for olefin polymerization.

In (a2) the second internal electron-donating compound-containing solid catalyst component for olefin polymerization, the tetravalent titanium halide compound, i.e., the raw material component as the source of titanium and halogen, is the same as the tetravalent titanium halide compound that is the raw material component as the source of titanium and halogen in (a1) the first internal electron-donating compound-containing solid catalyst component for olefin polymerization.

(a2) The second internal electron-donating compound-containing solid catalyst component for olefin polymerization contains the second internal electron-donating compound as the internal electron-donating compound.

The second internal electron-donating compound is an internal electron-donating compound other than the succinate diester compound. The second internal electron-donating compound is one or more selected from a diester compound other than the succinate diester, an ether carbonate compound, and a polyol ester compound. The presence of the second internal electron-donating compound as the internal electron-donating compound in the olefin polymerization catalyst makes it possible to produce a polypropylene polymer having a high MFR when an appropriate external donor is used during the time of polymerization.

The diester compound other than the succinate diester compound according to the second internal electron-donating compound includes a phthalate diester compound, a malonate diester compound, an alkylidenemalonate diester compound, a cyclohexanedicarboxylate ester compound, a cyclohexenedicarboxylate ester compound, a citraconate diester compound, and a phenylene dioate compound; among these, preferable are an alkylidenemalonate diester compound, a cyclohexanedicarboxylate ester compound, a 1-cyclohexene-1,2-dicarboxylate ester compound, a 4-cyclohexene-1,2-dicarboxylate ester compound, a citraconate diester compound, and a phenylenedibenzoate compound.

The second internal electron-donating compound includes ether carbonate compounds such as (2-ethoxyethyl) methyl carbonate, (2-ethoxyethyl) ethyl carbonate, (2-propoxyethyl) propyl carbonate, (2-butoxyethyl) butyl carbonate, (2-butoxyethyl) ethyl carbonate, (2-ethoxyethyl) propyl carbonate, (2-ethoxyethyl) phenyl carbonate, and (2-ethoxyethyl) p-methylphenyl carbonate.

The second internal electron-donating compound also includes polyol ester compounds such as 9,9-bis(benzoyloxymethyl) fluorene, 9,9-bis((m-methoxybenzoyloxy)methyl) fluorene, 9,9 bis((m-chlorobenzoyloxy)methyl) fluorene, 9,9-bis((p-chlorobenzoyloxy)methyl) fluorene, 9,9-bis(cinnamoyloxymethyl) fluorene, 9-(benzoyloxymethyl)-9-(propionyloxymethyl) fluorene, 9,9-bis(propionyloxymethyl) fluorene, 9,9-bis(acryloyloxymethyl) fluorene, 9,9-bis(pivalyloxymethyl) fluorene, and 9,9-fluorenedimethanol dibenzoate.

The phthalate diester compound is, for example, one or more compounds selected from phthalate diester compounds represented by the following general formula (6):

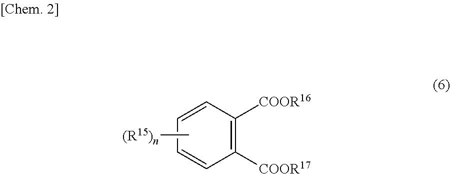

(in the general formula (6), R¹⁵ represents an alkyl group having the carbon number of 1 to 8 or a halogen atom, R¹⁶ and R¹⁷ represent an alkyl group having the carbon number of 1 to 12, in which R¹⁶ and R¹⁷ are optionally identical or different from each other, and the number n of a substituent R¹⁵ represents 0, 1, or 2, in which when n is 1, R¹⁵ is an alkyl group, and when n is 2, R¹⁵ is optionally identical or different from each other, but at least one of them is an alkyl group).

In the phthalate diester compound represented by the general formula (6), R¹⁵ represents an alkyl group having the carbon number of 1 to 8, or a halogen atom, preferably a linear alkyl group having the carbon number of 1 to 8, a branched alkyl group having the carbon number of 3 to 8, or a halogen atom.

When R¹⁵ is a halogen atom, the halogen atom includes at least one halogen atom selected from a fluorine atom, a chlorine atom, a bromine atom, and an iodine atom.

When R¹⁵ is a linear alkyl group having the carbon number of 1 to 8, or a branched alkyl group having the carbon number of 3 to 8, the linear alkyl group having the carbon number of 1 to 8 includes at least one group selected from a methyl group, an ethyl group, an n-propyl group, an n-butyl group, an n-pentyl group, an n-hexyl group, an n-heptyl group, and an n-octyl group; and the branched alkyl group having the carbon number of 3 to 8 includes at least one group selected from an isopropyl group, an isobutyl group, a t-butyl group, an isopentyl group, a neopentyl group, an isohexyl group, a 2,2-dimethylbutyl group, a 2,2-dimethylpentyl group, an isooctyl group, and a 2,2-dimethylhexyl group.

R¹⁵ is preferably a methyl group, a bromine atom, and a fluorine atom; a methyl group and a bromine atom are more preferable.

In the phthalate diester compound represented by the general formula (6), R¹⁶ and R¹⁷ are a linear alkyl group having the carbon number of 1 to 12, preferably the carbon number of 1 to 8, or a branched alkyl group having the carbon number of 3 to 8, in which they are optionally identical or different from each other.

R¹⁶ and R¹⁷ include a methyl group, an ethyl group, an n-propyl group, an isopropyl group, an n-butyl group, an isobutyl group, a t-butyl group, a neopentyl group, an isohexyl, and an isooctyl group; among these, an ethyl group, an n-propyl group, an n-butyl group, an isobutyl group, and a neopentyl group are preferable.

In the phthalate diester compound represented by the general formula (6), n is 0, 1, or 2 as the number of substituents in R¹⁵. When n is 1, R¹⁵ is an alkyl group, and when n is 2, R¹⁵ is optionally identical or different from each other, in which at least one of them is an alkyl group.

There is no particular restriction in the phthalate diester compound. Illustrative examples of the phthalate diester compound include: phthalate diesters such as dimethyl phthalate, diethyl phthalate, di-n-propyl phthalate, diisopropyl phthalate, di-n-butyl phthalate, diisobutyl phthalate, di-n-pentyl phthalate, diisopentyl phthalate, dineopentyl phthalate, di-n-hexyl phthalate, ditexyl phthalate, methyl ethyl phthalate, (ethyl) n-propyl phthalate, ethyl isopropyl phthalate, (ethyl) n-butyl phthalate, ethyl isobutyl phthalate, (ethyl) n-pentyl phthalate, ethyl isopentyl phthalate, ethyl neopentyl phthalate, and (ethyl) n-hexyl phthalate; halogen-substituted phthalate diesters such as diethyl 4-chlorophthalate, di-n-propyl 4-chlorophthalate, diisopropyl 4-chlorophthalate, di-n-butyl 4-chlorophthalate, diisobutyl 4-chlorophthalate, diethyl 4-bromophthalate, di-n-propyl 4-bromophthalate, diisopropyl 4-bromophthalate, di-n-butyl 4-bromophthalate, and diisobutyl 4-bromophthalate; and alkyl-substituted phthalate diesters such as diethyl 4-methylphthalate, di-n-propyl 4-methylphthalate, diisopropyl 4-methylphthalate, di-n-butyl 4-methylphthalate, and diisobutyl 4-methylphthalate.

The phthalate diester compound may be used singly or in a combination of two or more of those described above.

The malonate diester compounds are, for example, those represented by the following general formula (7):

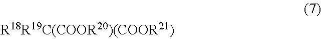

(in general formula (7), R¹⁸ and R¹⁹, which are optionally identical or different from each other, represent a hydrogen atom, a halogen atom, a linear alkyl group having the carbon number of 1 to 20, a branched alkyl group having the carbon number of 3 to 20, a cycloalkyl or a cycloalkenyl group having the carbon number of 3 to 20, an aromatic hydrocarbon group having the carbon number of 6 to 12, a vinyl group, a linear or a branched alkenyl group having the carbon number of 3 to 20, and an alkyl group substituted with one or two halogen atoms and having the carbon number of 1 to 10. R²⁰ and R²¹, which are optionally identical or different from each other, represent a linear alkyl group having the carbon number of 1 to 20, a branched alkyl group having the carbon number of 3 to 20, a cycloalkyl or a cycloalkenyl group having the carbon umber of 3 to 20, an aromatic hydrocarbon group having the carbon number of 6 to 12, a vinyl group, or a linear or a branched alkenyl group having the carbon number of 3 to 20.)

In the malonate diester compound represented by the above general formula (7), when R¹⁸ and R¹⁹ are a halogen atom, the halogen atom is a chlorine atom, a bromine atom, an iodine atom, or a fluorine atom, preferably a chlorine atom or a bromine atom. R¹⁸ and R¹⁹ are preferably a branched alkyl group having the carbon number of 3 to 10 containing at least one secondary, tertiary, or quaternary carbon; among them, an isobutyl group, a t-butyl group, an isopentyl group, and a neopentyl group are preferable.

In the malonate diester compound represented by the general formula (7), R²⁰ and R²¹, which are the carbonyl ester residues thereof, are preferably an alkyl group, especially preferably a linear alkyl group having the carbon number of 1 to 8 or a branched alkyl group having the carbon number of 3 to 8; specifically, they are a methyl group, an ethyl group, an n-propyl group, an isopropyl group, an n-butyl group, an isobutyl group, a t-butyl group, an n-pentyl group, an isopentyl group, a neopentyl group, an n-heptyl group, a 2,2-dimethylpentyl group, and an isooctyl group.

There is no particular restriction in the malonate diester compound. Illustrative examples thereof include: unsubstituted malonate diesters such as diethyl malonate, di-n-propyl malonate, diisopropyl malonate, di-n-butyl malonate, diisobutyl malonate, di-n-pentyl malonate, di-neopentyl malonate, and diisooctyl malonate;
monoalkylmalonate diesters such as dimethyl methylmalonate, diethyl methylmalonate, di-n-propyl methylmalonate, diisopropyl methylmalonate, di-n-butyl methylmalonate, diisobutyl methylmalonate, di-neopentyl methylmalonate, diisooctyl methylmalonate, dimethyl ethylmalonate, diethyl ethylmalonate, di-n-propyl ethylmalonate, diisopropyl ethylmalonate, di-n-butyl ethylmalonate, diisobutyl ethylmalonate, di-neopentyl ethylmalonate, diisooctyl ethylmalonate, dimethyl propylmalonate, diethyl isopropylmalonate, dipropyl isopropylmalonate, diisoporpyl isopropylmalonate, di-n-butyl isopropylmalonate, diisobutyl isopropylmalonate, di-neopentyl isopropylmalonate, diisoctyl isopropylmalonate, dimethyl isobutylmalonate, diethyl isobutylmalonate, di-n-propyl isobutylmalonate, diisopropyl isobutylmalonate, di-n-butyl isobutylmalonate, diisobutyl isobutylmalonate, dineopentyl isobutylmalonate, diisooctyl isobutylmalonate, dimethyl isopentylmalonate, diethyl isopentylmalonate, di-n-propyl isopentylmalonate, diisopropyl isopentylmalonate, di-n-butyl isopentylmalonate, diisobutyl isopentylmalonate, di-neopentyl isopentylmalonate, and diisooctyl isopentylmalonate;
dialkylmalonate diesters such as dimethyl ethylcyclopentylmalonate, diethyl ethylcyclopentylmalonate, dimethyl diisopropylmalonate, diethyl diisopropylmalonate, di-n-propyl diisopropylmalonate, diisopropyl diisopropylmalonate, di-n-butyl diisopropylmalonate, ethyl n-pentyl diisobutylmalonate, diisobutyl diisopropylmalonate, di-neopentyl diisopropylmalonate, diisooctyl diisobutylmalonate, dimethyl diisobutylmalonate, diethyl diisobutylmalonate, di-n-propyl diisobutylmalonate, diisopropyl diisobutylmalonate, di-n-butyl diisobutylmalonate, diisobutyl diisobutylmalonate, ethyl isobutyl diisobutylmalonate, di-n-pentyl diisobutylmalonate, di-neopentyl diisobutylmalonate, diisooctyl diisopentylmalonate, diethyl diisopentylmalonate, di-n-propyl diisopentylmalonate, diisopropyl diisopentylmalonate, di-n-butyl diisopentylmalonate, diisobutyl diisopentylmalonate, di-neopentyl diisopentylmalonate, diethyl isopropylisobutylmalonate, di-n-propyl isopropylisobutylmalonate, diisopropyl isopropylisobutylmalonate, di-n-butyl isopropylisobutylmalonate, diisobutyl isopropylisobutylmalonate, di-neopentyl isopropylisobutylmalonate, dimethyl isopropylisopentylmalonate, diethyl isopropylisopentylmalonate, di-n-propyl isopropylisopentylmalonate, diisopropyl isopropylisopentylmalonate, di-n-butyl isopropylisopentylmalonate, diisobutyl isopropylisopentylmalonate, and dineopentyl isopropylisopentylmalonate.

Among these, a monoalkylmalonate diester and a dialkylmalonate diester are preferable; dimethyl ethylcyclopentylmalonate, diethyl ethylcyclopentylmalonate, dimethyl diisobutylmalonate, diethyl diisobutylmalonate, and diisopropyl diisobutylmalonate are especially preferable.

The malonate diester compound may be used singly or in a combination of two or more of those described above.

The alkylidenemalonate diester compound is, for example, one or more compounds selected from alkylidenemalonate diester compounds represented by the following general formula (8):

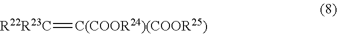

(in the formula, R²² and R²³ independently represent a group or an atom selected from a hydrogen atom, a halogen atom, a linear alkyl group having the carbon number of 1 to 20, a branched alkyl group having the carbon number of 3 to 20, a vinyl group, a linear or a branched alkenyl group having the carbon number of 3 to 20, a halogen-substituted alkyl group having the carbon number of 2 to 20, a cycloalkyl or a cycloalkenyl group having the carbon number of 3 to 20, an aromatic hydrocarbon group having the carbon number of 6 to 20, a nitrogen-containing group, an oxygen-containing group, a phosphorus-containing group, and a silicon-containing group, in which R²² and R²³ are optionally identical or different from each other and are optionally bonded together to form a ring, and when R²² is a hydrogen atom or a methyl group, R²³ has two or more carbon atoms. R²⁴ and R²⁵ independently represent a linear alkyl group having the carbon number of 1 to 20, a branched alkyl group having the carbon number of 3 to 20, a vinyl group, a linear or a branched alkenyl group having the carbon number of 3 to 20, a cycloalkyl or a cycloalkenyl group having the carbon number of 3 to 20, or an aromatic hydrocarbon group having the carbon number of 6 to 20, in which R²⁴ and R²⁵ are optionally identical or different from each other).

In the alkylidenemalonate diester compound represented by the general formula (8), when R²² and R²³ are a halogen atom, the halogen atom is a chlorine atom, a bromine atom, an iodine atom, or a fluorine atom, preferably a chlorine atom, a bromine atom, or an iodine atom, and more preferably a chlorine atom or a bromine atom.

R²² and R²³ include a linear alkyl group having the carbon number of 1 to 20 such as a methyl group, an ethyl group, an n-propyl group, an n-butyl group, an n-pentyl group, an n-hexyl group, an n-heptyl group, an n-octyl group, an n-nonyl group, and an n-decyl group.

R²² and R²³ include a branched alkyl group having the carbon number of 3 to 20 and containing a secondary carbon atom or a tertiary carbon atom, such as an isopropyl group, an isobutyl group, a t-butyl group, an isopentyl group, and a neopentyl group.

R²² and R²³ include a linear alkenyl group having the carbon number of 3 to 20, such as an n-propenyl group, an n-butenyl group, an n-pentenyl group, an n-hexenyl group, an n-heptenyl group, an n-octenyl group, an n-nonenyl group, and an n-decenyl group.

R²² and R²³ include a branched alkenyl group having the carbon number of 3 to 20 containing a secondary carbon atom or a tertiary carbon atom, such as an isopropenyl group, an isobutenyl group, a t-butenyl group, an isopentenyl group, and a neopentenyl group.

R²² and R²³ include a linear or a branched halogen-substituted alkyl group having the carbon number of 2 to 20, such as a methyl halide group, an ethyl halide group, an n-propyl halide group, an isopropyl halide group, an n-butyl halide group, an isobutyl halide group, an n-pentyl halide group, an n-hexyl halide group, an n-heptyl halide group, an n-octyl halide group, a nonyl halide group, and a decyl halide group. The halogen atom in these halogen-substituted alkyl groups includes a fluorine atom, a chlorine atom, a bromine atom, and an iodine atom.

R²² and R²³ include a cycloalkyl group having the carbon number of 3 to 20, such as a cyclopropyl group, a cyclobutyl group, a cyclopentyl group, a cyclohexyl group, a cycloheptyl group, a cyclooctyl group, a cyclononyl group, and a cyclodecyl group.

R²² and R²³ include a cycloalkenyl group having the carbon number of 3 to 20, such as a cyclopropenyl group, a cyclobutenyl group, a cyclopentenyl group, a cyclohexenyl group, a cycloheptenyl group, a cyclooctenyl group, a cyclononenyl group, and cyclodecenyl group.

R²² and R²³ include an aromatic hydrocarbon group having the carbon number of 6 to 20, such as a phenyl group, a methylphenyl group, a dimethylphenyl group, an ethylphenyl group, a benzyl group, a 1-phenylethyl group, a 2-phenylethyl group, a 2-phenylpropyl group, a 1-phenylbutyl group, a 4-phenylbutyl group, a 2-phenylheptyl group, a tolyl group, a xylyl group, and a naphthyl group.

When R²² is a hydrogen atom or a methyl group, the number of the carbon atom in R²³ is 2 or more. R²² and R²³ are optionally combined with each other to form a ring. Examples of the ring formed by the carbon atoms bonded to R²² or R²³, and to R²² and R²³ include a cycloalkyl ring, a fluorenyl ring, an indenyl ring, an imidazole ring, and a piperidinyl ring.

R²² and R²³ are preferably a hydrogen atom, a linear alkyl group having the carbon number of 1 to 6, a branched alkyl group having the carbon number of 3 to 6, a vinyl group, a linear or a branched alkenyl group having the carbon number of 3 to 6, a cycloalkyl group having the carbon number of 5 or 6, a cycloalkenyl group having the carbon number of 5 or 6, or an aromatic hydrocarbon group having the carbon number of 6 to 10. It is especially preferable that R²² is a hydrogen atom or a linear alkyl group having the carbon number of 1 to 6, and R²³ is a linear alkyl group having the carbon number of 1 to 6, a branched alkyl group having the carbon number of 3 to 6, a cycloalkyl group having the carbon number of 5 or 6, or an aromatic hydrocarbon group having the carbon number of 6 to 10.

It is preferable that R²⁴ and R²⁵ are a linear alkyl group having the carbon number of 1 to 10 or a branched alkyl group having the carbon number of 3 to 8. It is especially preferable that R²⁴ and R²⁵ are a linear alkyl group having the carbon number of 1 to 4 or a branched alkyl group having the carbon number of 3 or 4.

Illustrative examples of the alkylidenemalonate diester compound include: linear alkylidene malonate diesters such as dimethyl propylidenemalonate, diethyl propylidenemalonate, di-n-propyl propylidenemalonate, diisobutyl propylidenemalonate, di-n-butyl propylidenemalonate, dimethyl butylidenemalonate, diethyl butylidenemalonate, di-n-propyl butylidenemalonate, diisobutyl butylidenemalonate, di-n-butyl butylidenemalonate, dimethyl pentylidenemalonate, diethyl pentylidenemalonate, di-n-propyl pentylidenemalonate, diisobutyl pentylidenemalonate, di-n-butyl pentylidenemalonate; dimethyl hexylidenemalonate, diethyl hexylidenemalonate, di-n-propyl hexylidenemalonate, diisobutyl hexylidenemalonate, and di-n-butyl hexylidenemalonate;
(linear alkylalkylidene)malonate diesters such as dimethyl (1-methylpropylidene)malonate, diethyl (1-methylpropylidene)malonate, di-n-propyl (1-methylpropylidene)malonate, diisobutyl (1-methylpropylidene)malonate, di-n-butyl (1-methylpropylidene)malonate, diethyl (1-ethylpropylidene)malonate, dimethyl (2-methylpropylidene)malonate, diethyl (2-methylpropylidene)malonate, di-n-propyl (2-methylpropylidene)malonate, diisobutyl (2-methylpropylidene)malonate, di-n-butyl (2-methylpropylidene)malonate, diethyl (2,2-dimethylpropylidene)malonate; dimethyl (-methylbutylidene)malonate, diethyl (2-methylbutylidene)malonate, di-n-propyl (2-methylbutylidene)malonate, diisobutyl (2-methylbutylidene)malonate, di-n-butyl (2-methylbutylidene)malonate, dimethyl (2-ethylbutylidene)malonate, diethyl (2-ethylbutylidene)malonate, di-n-propyl (2-ethylbutylidene)malonate, diisobutyl (2-ethylbutylidene)malonate, di-n-butyl (2-ethylbutylidene)malonate, dimethyl (2-ethylpentylidene)malonate, diethyl (2-ethylpentylidene)malonate, di-n-propyl (2-ethylpentylidene)malonate, diisobutyl (2-ethylpentylidene)malonate, di-n-butyl (2-ethylpentylidene)malonate, dimethyl (2-isopropylbutylidene)malonate, diethyl (2-isopropylbutylidene)malonate, di-n-propyl (2-isopropylbutylidene)malonate, diisobutyl (2-isopropylbutylidene)malonate, di-n-butyl (2-isopropylbutylidene)malonate, dimethyl (3-methylbutylidene)malonate, diethyl (3-methylbutylidene)malonate, di-n-propyl (3-methylbutylidene)malonate, diisobutyl (3-methylbutylidene)malonate, di-n-butyl (3-methylbutylidene)malonate, dimethyl (2,3-dimethylbutylidene)malonate, diethyl (2,3-dimethylbutylidene)malonate, di-n-propyl (2,3-dimethylbutylidene)malonate, diisobutyl (2,3-dimethylbutylidene)malonate, di-n-butyl (2,3-dimethylbutylidene)malonate, dimethyl (2-n-propylbutylidene)malonate, diethyl (2-n-propylbutylidene)malonate, di-n-propyl (2-n-propylbutylidene)malonate, diisobutyl (2-n-propylbutylidene)malonate, di-n-butyl (2-n-propylbutylidene)malonate, dimethyl (2-isobutyl-3-methylbutylidene)malonate, diethyl (2-isobutyl-3-methylbutylidene)malonate, di-n-propyl (2-isobutyl-3-methylbutylidene)malonate, diisobutyl (2-isobutyl-3-methylbutylidene)malonate, di-n-butyl (2-isobutyl-3-methylbutylidene)malonate, dimethyl (2-n-butylpentylidene)malonate, diethyl (2-n-butylpentylidene)malonate, di-n-propyl (2-n-butylpentylidene)malonate, diisobutyl (2-n-butylpentylidene) malonate, di-n-butyl (2-n-butylpentylidene) malonate, dimethyl (2-n-pentylhexylidene) malonate, diethyl (2-n-pentylhexylidene) malonate, di-n-propyl (2-n-pentylhexylidene) malonate, diisobutyl (2-n-pentylhexylidene) malonate, and di-n-butyl (2-n-pentylhexylidene) malonate;
(branched alkylmethylene) malonate diesters such as dimethyl (di-t-butylmethylene) malonate, diethyl (di-t-butylmethylene)malonate, di-n-propyl (di-t-butylmethylene)malonate, diisobutyl (di-t-butylmethylene)malonate, di-n-butyl (di-t-butylmethylene)malonate, dimethyl (diisobutylmethylene)malonate, diethyl (diisobutylmethylene)malonate, di-n-propyl (diisobutylmethylene)malonate, diisobutyl (diisobutylmethylene)malonate, di-n-butyl (diisobutylmethylene)malonate, dimethyl (diisopropylmethylene)malonate, diethyl (diisopropylmethylene)malonate, di-n-propyl (diisopropylmethylene)malonate, diisobutyl (diisopropylmethylene)malonate, and di-n-butyl (diisopropylmethylene)malonate;
(cycloalkylmethylene)malonate diesters such as dimethyl (cyclohexylmethylene)malonate, diethyl (cyclohexylmethylene)malonate, di-n-propyl (cyclohexylmethylene)malonate, diisobutyl (cyclohexylmethylene)malonate, di-n-butyl (cyclohexylmethylene)malonate, dimethyl (cyclopentylmethylene)malonate, diethyl (cyclopentylmethylene)malonate, di-n-propyl (cyclopentylmethylene)malonate, diisobutyl (cyclopentylmethylene)malonate, di-n-butyl (cyclopentylmethylene)malonate, dimethyl (dicyclopentylmethylene)malonate, diethyl (dicyclopentylmethylene)malonate, di-n-propyl (dicyclopentylmethylene)malonate, diisobutyl (dicyclopentylmethylene)malonate, di-n-butyl (dicyclopentylmethylene)malonate, dimethyl (dicyclohexylmethylene)malonate, diethyl (dicyclohexylmethylene)malonate, di-n-propyl (dicyclohexylmethylene)malonate, diisobutyl (dicyclohexylmethylene)malonate, and di-n-butyl (dicyclohexylmethylene)malonate;
(alkyl-substituted cycloalkylmethylene)malonate diesters such as dimethyl (2-methylcyclohexylmethylene)malonate, diethyl (2-methylcyclohexylmethylene)malonate, di-n-propyl (2-methylcyclohexylmethylene)malonate, diisobutyl (2-methylcyclohexylmethylene)malonate, di-n-butyl (2-methylcyclohexylmethylene)malonate; dimethyl (2,6-dimethylcyclohexylmethylene)malonate, diethyl (2,6-dimethylcyclohexylmethylene)malonate, di-n-propyl (2,6-dimethylcyclohexylmethylene)malonate, diisobutyl (2,6-dimethylcyclohexylmethylene)malonate, di-n-butyl (2,6-dimethylcyclohexylmethylene)malonate; dimethyl (1-methyl-1-(2-methylcyclohexyl)methylene)malonate, diethyl (1-methyl-1-(2-methylcyclohexyl)methylene)malonate, di-n-propyl (1-methyl-1-(2-methylcyclohexyl)methylene)malonate, diisobutyl (1-methyl-1-(2-methylcyclohexyl)methylene)malonate, and di-n-butyl (1-methyl-1-(2-methylcyclohexyl)methylene)malonate;
benzylidenemalonate diesters such as dimethyl benzylidenemalonate, diethyl benzylidenemalonate, di-n-propyl benzylidenemalonate, ethyl n-propyl benzylidenemalonate, diisopropyl benzylidenemalonate, ethyl isopropyl benzylidene malonate, diisobutyl benzylidenemalonate, ethyl isobutyl benzylidenemalonate, di-n-butyl benzylidenemalonate, ethyl n-butyl benzylidenemalonate, di-n-pentyl benzylidenemalonate, di-neopentyl benzylidenemalonate, di-n-hexyl benzylidenemalonate, di-n-octyl benzylidenemalonate, bis(2-ethylhexyl) benzylidenemalonate, and ethyl (2-ethylhexyl) benzylidenemalonate;
linear alkyl benzylidenemalonate diesters such as dimethyl (1-methylbenzylidene)malonate, diethyl (1-methylbenzylidene)malonate, di-n-propyl (1-methylbenzylidene)malonate, diisobutyl (1-methylbenzylidene)malonate, di-n-butyl (1-methylbenzylidene)malonate, dimethyl (1-ethylbenzylidene)malonate, diethyl (1-ethylbenzylidene)malonate, di-n-propyl (1-ethylbenzylidene)malonate, diisobutyl (1-ethylbenzylidene)malonate, di-n-butyl (1-ethylbenzylidene)malonate, dimethyl (1-n-propylbenzylidene)malonate, diethyl (1-n-propylbenzylidene)malonate, di-n-propyl (1-n-propylbenzylidene)malonate, diisobutyl (1-n-propylbenzylidene)malonate, di-n-butyl (1-n-propylbenzylidene)malonate, dimethyl (1-n-butylbenzylidene)malonate, diethyl (1-n-butylbenzylidene)malonate, di-n-propyl (1-n-butylbenzylidene)malonate, diisobutyl (1-n-butylbenzylidene)malonate, di-n-butyl (1-n-butylbenzylidene)malonate, dimethyl (1-n-pentylbenzylidene)malonate, diethyl (1-n-pentylbenzylidene)malonate, di-n-propyl (1-n-pentylbenzylidene)malonate, diisobutyl (1-n-pentylbenzylidene)malonate, di-n-butyl (1-n-pentylbenzylidene)malonate, dimethyl (1-n-hexylbenzylidene)malonate, diethyl (1-n-hexylbenzylidene)malonate, di-n-propyl (1-n-hexylbenzylidene)malonate, diisobutyl (1-n-hexylbenzylidene)malonate, and di-n-butyl (1-n-hexylbenzylidene)malonate;
branched alkyl benzylidenemalonate diesters such as dimethyl (1-isopropylbenzylidene)malonate, diethyl (1-isopropylbenzylidene)malonate, di-n-propyl (1-isopropylbenzylidene)malonate, diisobutyl (1-isopropylbenzylidene)malonate, di-n-butyl (1-isopropylbenzylidene)malonate, dimethyl (1-isobutylbenzylidene)malonate, diethyl (1-isobutylbenzylidene)malonate, di-n-propyl (1-isobutylbenzylidene)malonate, diisobutyl (1-isobutylbenzylidene)malonate, di-n-butyl (1-isobutylbenzylidene)malonate, dimethyl (1-t-butylbenzylidene)malonate, diethyl (1-t-butylbenzylidene)malonate, di-n-propyl (1-t-butylbenzylidene)malonate, diisobutyl (1-t-butylbenzylidene)malonate, and di-n-butyl (1-t-butylbenzylidene)malonate;
(alkyl-substituted phenylmethylene)malonate diesters such as dimethyl (2-methylphenylmethylene)malonate, diethyl (2-methylphenylmethylene)malonate, di-n-propyl (2-methylphenylmethylene)malonate, diisobutyl (2-methylphenylmethylene)malonate, di-n-butyl (2-methylphenylmethylene)malonate, dimethyl (4-methylphenylmethylene)malonate; dimethyl (2,6-dimethylphenylmethylene)malonate, diethyl (2,6-dimethylphenylmethylene)malonate, di-n-propyl (2,6-dimethylphenylmethylene)malonate, diisobutyl (2,6-dimethylphenylmethylene)malonate, di-n-butyl (2,6-dimethylphenylmethylene)malonate, dimethyl (1-methyl-1-(2-methylphenyl)methylene)malonate, diethyl (1-methyl-1-(2-methylphenyl)methylene)malonate, di-n-propyl (1-methyl-1-(2-methylphenyl)methylene)malonate, diisobutyl (1-methyl-1-(2-methylphenyl)methylene)malonate, and di-n-butyl (1-methyl-1-(2-methylphenyl)methylene)malonate; and
(naphthylmethylene)malonate diesters such as dimethyl (naphthylmethylene)malonate, diethyl (naphthylmethylene)malonate, di-n-propyl (naphthylmethylene)malonate, diisobutyl (naphthylmethylene)malonate, and di-n-butyl (naphthylmethylene)malonate. As for the alkylidenemalonate diester compound, benzylidenemalonate diesters such as dimethyl benzylidenemalonate, diethyl benzylidenemalonate, di-n-propyl benzylidenemalonate, ethyl n-propyl benzylidenemalonate, diisopropyl benzylidenemalonate, ethyl isopropyl benzylidenemalonate, diisobutyl benzylidenemalonate, ethyl isobutyl benzylidenemalonate, di-n-butyl benzylidenemalonate, ethyl n-butyl benzylidenemalonate, di-n-pentyl benzylidenemalonate, di-neopentyl benzylidenemalonate, di-n-hexyl benzylidenemalonate, di-n-octyl benzylidenemalonate, bis(2-ethylhexyl) benzylidenemalonate, and ethyl (2-ethylhexyl) benzylidenemalonate are preferably used; diethyl benzylidenemalonate, di-n-propyl benzylidenemalonate, ethyl n-propyl benzylidenemalonate, diisopropyl benzylidenemalonate, ethyl isopropyl benzylidenemalonate. diisobutyl benzylidenemalonate, ethyl isobutyl benzylidenemalonate, di-n-butyl benzylidenemalonate, ethyl n-butyl benzylidenemalonate, di-neopentyl benzylidenemalonate, di-n-hexyl benzylidenemalonate, and diisooctyl benzylidenemalonate are especially preferably used.

The alkylidenemalonate diester compound may be used singly or in a combination of two or more of those described above.

There is no particular restriction in the cyclohexanedicarboxylate ester compound; illustrative examples thereof include compounds having a cycloalkane-1,2-dicarboxylate diester structure, such as dimethyl cyclohexane-1,2-dicarboxylate, diethyl cyclohexane-1,2-dicarboxylate, di-n-propyl cyclohexane-1,2-dicarboxylate, diisopropyl cyclohexane-1,2-dicarboxylate, ethyl n-butyl cyclohexane-1,2-dicarboxylate, ethyl isobutyl cyclohexane-1,2-dicarboxylate, di-n-butyl cyclohexane-1,2-dicarboxylate, diisobutyl cyclohexane-1,2-dicarboxylate, di-n-hexyl cyclohexane-1,2-dicarboxylate, di-n-heptyl cyclohexane-1,2-dicarboxylate, di-n-octyl cyclohexane-1,2-dicarboxylate, diisooctyl cyclohexane-1,2-dicarboxylate, and ethyl isooctyl cyclohexane-1,2-dicarboxyl). Among these, preferable are unsubstituted cycloalkane-1,2-dicarboxylate diesters such as diethyl cyclohexane-1,2-dicarboxylate, di-n-propyl cyclohexane-1,2-dicarboxylate, diisopropyl cyclohexane-1,2-dicarboxylate, ethyl n-butyl cyclohexane-1,2-dicarboxylate, ethyl isobutyl cyclohexane-1,2-dicarboxylate, di-n-butyl cyclohexane-1,2-dicarboxylate, diisobutyl cyclohexane-1,2-dicarboxylate, diisooctyl cyclohexane-1,2-dicarboxylate, and ethyl isooctyl cyclohexane-1,2-dicarboxylate, as well as substituted cycloalkane dicarboxylate diesters in which a portion of the hydrogen atom of the cycloalkyl structure is substituted with an alkyl group or the like, such as diethyl 3-methylcyclohexane-1,2-dicarboxylate, diethyl 4-methylcyclohexane-1,2-dicarboxylate, diethyl 5-methylcyclohexane-1,2-dicarboxylate, diethyl 3,6-dimethylcyclohexane-1,2-dicarboxylate, and di-n-butyl 3,6-dimethylcyclohexane-1,2-dicarboxylate; among these, diethyl cyclohexane-1,2-dicarboxylate, di-n-propyl cyclohexane-1,2-dicarboxylate, diisopropyl cyclohexane-1,2-dicarboxylate, ethyl n-butyl cyclohexane-1,2-dicarboxylate, ethyl isobutyl cyclohexane-1,2-dicarboxylate, di-n-butyl cyclohexane-1,2-dicarboxylate, diisobutyl cyclohexane-1,2-dicarboxylate, diisooctyl cyclohexane-1,2-dicarboxylate, and ethyl isooctyl cyclohexane-1,2-dicarboxylate are more preferable.

The cyclohexanedicarboxylate ester compound may be used singly or in a combination of two or more of those described above.

The cyclohexenedicarboxylate ester compound includes one or more compounds selected from, for example, substituted or unsubstituted 1-cyclohexene-1,2-dicarboxylate diesters having an alkoxycarbonyl group bonded to the first and second positions of the cyclohexene ring of 1-cyclohexene, or a substituted or an unsubstituted 4-cyclohexene-1,2-dicarboxylate diester having an alkoxycarbonyl group bonded to the first and second positions of the cyclohexene ring of 4-cyclohexene.

There is no particular restriction in the cyclohexene dicarboxylate ester compound. Illustrative examples thereof include diethyl 1-cyclohexene-1,2-dicarboxylate, di-n-propyl 1-cyclohexene-1,2-dicarboxylate, di-n-butyl 1-cyclohexene-1,2-dicarboxylate, diisobutyl 1-cyclohexene-1,2-dicarboxylate, dineopentyl 1-cyclohexene-1,2-dicarboxylate, diisooctyl 1-cyclohexene-1,2-dicarboxylate, bis(2,2-dimethylhexyl) 1-cyclohexene-1,2-dicarboxylate, diethyl 4-cyclohexene-1,2-dicarboxylate, di-n-propyl 4-cyclohexene-1,2-dicarboxylate, di-n-butyl 4-cyclohexene-1,2-dicarboxylate, diisobutyl 4-cyclohexene-1,2-dicarboxylate, dineopentyl 4-cyclohexene-1,2-dicarboxylate, diisooctyl 4-cyclohexene-1,2-dicarboxylate, and bis(2,2-dimethylhexyl) 4-cyclohexene-1,2-dicarboxylate. Among these, diethyl 1-cyclohexene-1,2-dicarboxylate, di-n-butyl 1-cyclohexene-1,2-dicarboxylate, diisobutyl 1-cyclohexene-1,2-dicarboxylate, dineopentyl 1-cyclohexene-1,2-dicarboxylate, diisooctyl 1-cyclohexene-1,2-dicarboxylate, diethyl 4-cyclohexene-1,2-dicarboxylate, di-n-butyl 4-cyclohexene-1,2-dicarboxylate, diisobutyl 4-cyclohexene-1,2-dicarboxylate, dineopentyl 4-cyclohexene-1,2-dicarboxylate, and diisooctyl 4-cyclohexene-1,2-dicarboxylate are preferably used.

The cyclohexenedicarboxylate ester compound may be used singly or in a combination of two or more of those described above.

There is no particular restriction in the citraconate diester compound. Illustrative examples thereof include dimethyl citraconate, diethyl citraconate, di-n-propyl citraconate, diisopropyl citraconate, di-n-butyl citraconate, diisopropyl citraconate, di-n-butyl citraconate, diisobutyl citraconate, dineopentyl citraconate, diisooctyl citraconate, and bis(2,2-dimethylhexyl) citraconate. Among these, diethyl citraconate, di-n-butyl citraconate, diisobutyl citraconate, di-neopentyl citraconate, and bis(2-ethylhexyl) citraconate are preferably used.

The citraconate diester compound may be used singly or in a combination of two or more of those compounds described above.

The phenylene dioate compound is, for example, one or more compounds selected from phenylene dioate compounds represented by the following general formula (9):

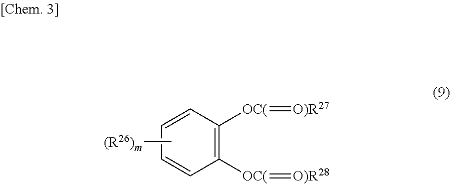

(in the formula (9), R²⁶ represents an alkyl group having the carbon number of 1 to 8 or a halogen atom, R²⁷ and R²⁸, which are optionally identical or different from each other, represent a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20; m represents the number of the substituent R²⁶ and is 0, 1, or 2; when m is 1, R²⁶ is an alkyl group; when m is 2, R²⁶ is optionally identical or different from each other, but at least one of them is an alkyl group).

In the phenylene dioate compound represented by the general formula (9), R²⁶ represents an alkyl group having the carbon number of 1 to 8 or a halogen atom, preferably a linear alkyl group having the carbon number of 1 to 8, a branched alkyl group having the carbon number f 3 to 8, or a halogen atom.

When R²⁶ is a halogen atom, the halogen atom includes at least one halogen atom selected from a fluorine atom, a chlorine atom, a bromine atom, and an iodine atom.

When R²⁶ is a linear alkyl group having the carbon number of 1 to 8, or a branched alkyl group having the carbon number of 3 to 8, the linear alkyl group having the carbon number of 1 to 8 includes at least one group selected from a methyl group, an ethyl group, an n-propyl group, an n-butyl group, an n-pentyl group, an n-hexyl group, an n-heptyl group, and an n-octyl group; and the branched alkyl group having the carbon number of 3 to 8 includes at least one group selected from an isopropyl group, an isobutyl group, a t-butyl group, an isopentyl group, a neopentyl group, an isohexyl group, a 2,2-dimethylbutyl group, a 2,2-dimethylpentyl group, an isooctyl group, and a 2,2-dimethylhexyl group.

As for R²⁶, among these, a chlorine atom, a bromine atom, a methyl group, an ethyl group, an n-propyl group, an isopropyl group, and an isobutyl group are preferable, and a chlorine atom, a bromine atom, a methyl group, and an isobutyl group are more preferable.

R²⁷ and R²⁸, which are optionally identical or different from each other, represent a linear alkyl group having the carbon number of 1 to 8, a branched alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 20.

There is no particular restriction in the phenylene dioate compound. Illustrative examples thereof include 1,2-phenylene diacetate, 1,2-phenylene diisopentanoate, 1,2-phenylene bis(2-ethylhexanoate), 1,2-phenylene dibenzoate, 4-chloro-1,2-phenylene diacetate, 4-chloro-1,2-phenylene diisopentanoate, 4-chloro-1,2-phenylene dibenzoate, 3-methyl-5-t-butyl-1,2-phenylene dibenzoate, 4-t-butyl-1,2-phenylene acetate, 4-t-butyl-1,2-phenylene bis(2-ethylhexanoate), and 4-t-butyl-1,2-phenylene dibenzoate.

The phenylene dioate compound may be used singly or in a combination of two or more of those compounds described above.

The ether carbonate compound is, for example, one or more compounds selected from ether carbonate compounds represented by the following general formula (10):

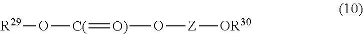

(in the general formula (10), R²⁹ and R³⁰ represent a linear alkyl group having the carbon number of 1 to 20, a branched alkyl group having the carbon number of 3 to 20, a vinyl group, a linear or a branched alkenyl group having the carbon number of 3 to 20, a linear halogen-substituted alkyl group having the carbon number of 1 to 20, a branched halogen-substituted alkyl group having the carbon number of 3 to 20, a cycloalkyl group having the carbon number of 3 to 20, a cycloalkenyl group having the carbon number of 3 to 20, an aromatic hydrocarbon group having the carbon number of 6 to 24 carbons, a nitrogen atom-containing hydrocarbon group having the carbon number of 2 to 24 and having a carbon atom at the bonding terminal thereof (except those having a C═N group at the bonding terminal thereof) or an oxygen atom-containing hydrocarbon group having the carbon number of 2 to 24 and having a carbon atom at the bonding terminal thereof (except those having a carbonyl group at the bonding terminal thereof), in which R²⁹ and R³⁰ are optionally identical or different from each other; and Z represents a carbon atom or a bonding group to bond via a carbon chain).

In the ether carbonate compound represented by the general formula (10), when R²⁹ and R³⁰ are a linear alkyl group having the carbon number of 1 to 20, illustrative examples thereof include a methyl group, an ethyl group, an n-propyl group, an n-butyl group, an n-pentyl group, an n-hexyl group, an n-pentyl group, an n-octyl group, an n-nonyl group, and an n-decyl group; a linear alkyl group having the carbon number of 1 to 12 is preferable.

When R²⁹ and R³⁰ are a branched alkyl group having the carbon number of 3 to 20, illustrative examples thereof include an alkyl group having a secondary carbon or a tertiary carbon, such as an isopropyl group, an isobutyl group, a t-butyl group, an isopentyl group, and a neopentyl group; a branched alkyl group having the carbon number of 3 to 12 is preferable.

When R²⁹ and R³⁰ are a linear or a branched alkenyl group having the carbon number of 3 to 20, illustrative examples thereof include an allyl group, a 3-butenyl group, a 4-hexenyl group, a 5-hexenyl group, a 7-octenyl group, a 10-dodecenyl group, an isopropenyl group, an isobutenyl group, an isopentenyl group, and a 2-ethyl-3-hexenyl group; a branched alkenyl group having the carbon number of 3 to 12 is preferable.

When R²⁹ and R³⁰ are a linear halogen-substituted alkyl group having the carbon number of 1 to 20, illustrative examples thereof include a methyl halide group, an ethyl halide group, an n-propyl halide group, an n-butyl halide group, an n-pentyl halide group, an n-hexyl halide group, an n-pentyl halide group, an n-octyl halide group, a nonyl halide group, a decyl halide group, a halogen-substituted undecyl group, and a halogen-substituted dodecyl group; a linear halogen-substituted alkyl group having the carbon number of 1 to 12 is preferable.

When R²⁹ and R³⁰ are a branched halogen-substituted alkyl group having the carbon number of 3 to 20, illustrative examples thereof include an isopropyl halide group, an isobutyl halide group, a 2-ethylhexyl halide group, and a neopentyl halide group; a branched halogen-substituted alkyl group having the carbon number of 3 to 12 is preferable.

When R²⁹ and R³⁰ are a cycloalkyl group having the carbon number of 3 to 20, illustrative examples thereof include a cyclopropyl group, a cyclobutyl group, a cyclopentyl group, a tetramethylcyclopentyl group, a cyclohexyl group, a methylcyclohexyl group, a cycloheptyl group, a cyclooctyl group, a cyclononyl group, a cyclodecyl group, and a butylcyclopentyl group; a cycloalkyl group having the carbon number of 3 to 12 is preferable.

When R²⁹ and R³⁰ are a cycloalkenyl group having the carbon number of 3 to 20, illustrative examples thereof include a cyclopropenyl group, a cyclopentenyl group, a cyclohexenyl group, a cyclooctenyl group, and a norbornene group; a cycloalkenyl group having the carbon number of 3 to 12 is preferable.

When R²⁹ and R³⁰ are an aromatic hydrocarbon group having the carbon number of 6 to 24, illustrative examples thereof include a phenyl group, a methylphenyl group, a dimethylphenyl group, an ethylphenyl group, a benzyl group, a 1-phenylethyl group, a 2-phenylethyl group, a 2-phenylpropyl group, a 1-phenylbutyl group, a 4-phenylbutyl group, a 2-phenylheptyl group, a tolyl group, a xylyl group, a naphthyl group, and a 1,8-dimethylnaphthyl group; an aromatic hydrocarbon group having the carbon number of 6 to 12 is preferable.

In the compound represented by the general formula (10), when R²⁹ and R³⁰ are a group containing a halogen atom, illustrative examples thereof include a fluorine atom, a chlorine atom, a bromine atom, and an iodine atom; among them, a fluorine atom, a chlorine atom, or a bromine atom is preferable. The bonding terminal of R²⁹ or R³⁰ means the oxygen atom side terminal atom or group to which R²⁹ or R³⁰ is bonded in the compound represented by the general formula (10).

R²⁹ is preferably a linear alkyl group having the carbon number of 1 to 12, a branched alkyl group having the carbon number of 3 to 12, a vinyl group, a linear alkenyl or branched alkenyl group having the carbon number of 3 to 12, a linear halogen-substituted alkyl group having the carbon number of 1 to 12, a branched halogen-substituted alkyl group having the carbon number of 3 to 12, a cycloalkyl group having the carbon number of 3 to 12, a cycloalkenyl group having the carbon number of 3 to 12, or an aromatic hydrocarbon group having the carbon number of 6 to 12; more preferable are a linear alkyl group having the carbon number of 1 to 12, a branched alkyl group having the carbon number of 3 to 12, a vinyl group, a linear alkenyl or a branched alkenyl group having the carbon number of 3 to 12, a linear halogen-substituted alkyl group having the carbon number of 1 to 12, a branched halogen-substituted alkyl group having the carbon number of 3 to 12, a cycloalkyl group having the carbon number of 3 to 12, a cycloalkenyl group having the carbon number of 3 to 12, and an aromatic hydrocarbon group having the carbon number of 6 to 12; still more preferable are a linear alkyl group having the carbon number of 1 to 12, a branched alkyl group having the carbon number of 3 to 12, and an aromatic hydrocarbon group having the carbon number of 6 to 12.

R³⁰ is preferably a linear alkyl group having the carbon number of 1 to 12, a branched alkyl group having the carbon number of 3 to 12 whose bonding terminal is —CH₂—, a vinyl group, a linear alkenyl group having the carbon number of 3 to 12, a branched alkenyl group having the carbon number of 3 to 12 whose bonding terminal is —CH₂, a linear halogen-substituted alkyl group having the carbon number of 1 to 12, a branched halogen-substituted alkyl group having the carbon number of 3 to 12 whose bonding terminal is —CH₂, a linear halogen-substituted alkenyl group having the carbon number of 3 to 12, a branched halogen-substituted alkenyl group having the carbon number of 3 to 12 whose bonding terminal is —CH₂, a cycloalkyl group having the carbon number of 4 to 12 whose bonding terminal is —CH₂, a cycloalkenyl group having the carbon number of 4 to 12 whose bonding terminal is —CH₂, a halogen-substituted cycloalkyl group having the carbon number of 4 to 12 whose bonding terminal is —CH₂, a halogen-substituted cycloalkenyl group having the carbon number of 4 to 12 whose bonding terminal is —CH₂, or an aromatic hydrocarbon group having the carbon number of 7 to 12 whose bonding terminal is —CH₂; more preferable are a linear alkyl group having the carbon number of 1 to 12, a branched alkyl group having the carbon number of 3 to 12 whose bonding terminal is —CH₂, a branched alkenyl group having the carbon number of 3 to 12 whose bonding terminal is —CH₂, a linear halogen-substituted alkyl group having the carbon number of 1 to 12 whose bonding terminal is —CH₂, a branched halogen-substituted alkyl group having the carbon number of 3 to 12 whose bonding terminal is —CH₂, a cycloalkyl group having the carbon number of 4 to 12 whose bonding terminal is —CH₂, a cycloalkenyl group having the carbon number of 4 to 12 whose bonding terminal is —CH₂, and an aromatic hydrocarbon group having the carbon number of 7 to 12 whose bonding terminal is —CH₂; and still more preferable are a linear hydrocarbon group having the carbon number of 1 to 12, a branched alkyl group having the carbon number of 3 to 12 whose bonding terminal is —CH₂, and an aromatic hydrocarbon group having the carbon number of 7 to 12 whose bonding terminal is —CH₂. The bonding terminal of R³⁰ means the oxygen atom side terminal to which R³⁰ is bonded in the compound represented by the general formula (10).

In the ether carbonate compound represented by the general formula (10), Z is a divalent bonding group that bonds the carbonate group to the ether group (OR³⁰ group), a bonding group that bonds via a carbon atom or a carbon chain, for example, a bonding group that bonds between two oxygen atoms to which Z is bonded by a carbon chain, in which the carbon chain is preferably a bonding group composed of two carbon atoms.

Z represents a linear alkylene group having the carbon number of 2 to 20, a branched alkylene group having the carbon number of 3 to 20, a vinylene group, a linear or a branched alkenylene group having the carbon number of 3 to 20, a linear halogen-substituted alkylene group having the carbon number of 2 to 20, a branched halogen-substituted alkylene group having the carbon number of 3 to 20, a cycloalkylene group having the carbon number of 3 to 20, a cycloalkenylene group having the carbon number of 3 to 20, an aromatic hydrocarbon group having the carbon number of 6 to 24, a nitrogen atom-containing hydrocarbon group having the carbon number of 1 to 24, an oxygen atom-containing hydrocarbon group having the carbon number of 1 to 24, or a phosphorous-containing hydrocarbon group having the carbon number of 1 to 24; among these, and more preferable are a bidentate bonding group selected from an ethylene group having the carbon number of 2 and a branched alkylene group having the carbon number of 3 to 12 (note that the bidentate bonding group means the group in which the two oxygen atoms to which Z is bonded are joined by a carbon chain that is composed of two carbon atoms.)

When Z is the linear alkylene group having the carbon number of 2 to 20, illustrative examples thereof include an ethylene group, a trimethylene group, a tetramethylene group, a pentamethylene group, a hexamethylene group, a heptamethylene group, an octamethylene group, a nonamethylene group, a decamethylene group, a undecamethylene group, and a dodecamethylene group; a linear alkylene group having the carbon number of 2 to 12 is preferable. An ethylene group is still more preferable.

Illustrative examples of Z that is a branched alkylene group having the carbon number of 3 to 20 include a 1-methylethylene group, a 2-methyltrimethylene group, a 2-methyltetramethylene group, a 2-methylpentamethylene group, a 3-methylhexamethylene group, a 4-methylheptamethylene group, a 4-methyloctamethylene group, a 5-methylnonamethylene group, a 5-methyldecamethylene group, a 6-methylundecamethylene group, a 7-methyldodecamethylene group, and a 7-methyltridecamethylene group; a branched alkylene group having the carbon number of 3 to 12 is preferable, and 1-methylethylene group, a 2-methylethylene group, and a 1-ethylethylene group are more preferable.

When Z is the linear or a branched alkenylene group having the carbon number of 3 to 20, illustrative examples thereof include a propenylene group, a butenylene group, a hexenylene group, an octenylene group, an octadecenylene group, an isopropenylene group, a 1-ethylethenylene group, a 2-methylpropenylene group, a 2,2-dimethylbutenylene group, a 3-methyl-2-butenylene group, a 3-ethyl-2-butenylene group, a 2-methyloctenylene group, and a 2,4-dimethyl-2-butenylene group; a linear alkenylene group having the carbon number of 3 to 12 and a branched alkenylene group having the carbon number of 3 to 12 whose bonding portion is an ethenylene group are preferable, and an isopropenylene group and a 1-ethylethenylene group are more preferable.

When Z is the linear halogen-substituted alkylene group having the carbon number of 2 to 20, illustrative examples thereof include a dichloromethylene group, a chloromethylene group, a dichloromethylene group, and a tetrachloroethylene group; a linear halogen-substituted alkylene group having the carbon number of 3 to 12 is preferable, and a chloroethylene group, a fluoroethylene group, a dichloroethylene group, a difluoroethylene group, and a tetrafluoroethylene group are more preferable.

When Z is the branched halogen-substituted alkylene group having the carbon number of 3 to 20, illustrative examples thereof include a 1,2-bischloromethylethylene group, a 2,2-bis(chloromethyl)propylene group, a 1,2-bisdichloromethylethylene group, a 1,2-bis(trichloromethyl)ethylene group, a 2,2-dichloropropylene group, a 1,1,2,2-tetrachloroethylene group, a 1-trifluoromethylethylene group, and a 1-pentafluorophenylethylene group; a branched halogen-substituted alkylene group having the carbon number of 3 to 12 is preferable, and a 1-chloroethylethylene group, a 1-trifluoromethylethylene group, and a 1,2-bis(chloromethyl)ethylene group are more preferable.

When Z is the cycloalkylene group having the carbon number of 3 to 20, illustrative examples thereof include a cyclopentylene group, a cyclohexylene group, a cyclopropylene group, a 2-methylcyclopropylene group, a cyclobutylene group, a 2,2-dimethylcyclobutylene group, a 2,3-dimethylcyclopentylene group, 1,3,3-trimethylcyclohexylene group, and a cyclooctylene group; a cycloalkylene group having the carbon number of 3 to 12 is preferable, and a 1,2-cycloalkylene group and a hydrocarbon-substituted-1,2-cycloalkylene group are more preferable.

When Z is the cycloalkenylene group having the carbon number of 3 to 20, illustrative examples thereof include a cyclopentenylene group, a 2,4-cyclopentadienylene group, a cyclohexenylene group, a 1,4-cyclohexadienylene group, a cycloheptenylene group, a methylcyclopentenylene group, a methylcyclohexenylene group, a methylcycloheptenylene group, a dicyclodecylene group, and a tricyclodecylene group; a cycloalkenylene group having the carbon number of 3 to 12 is preferable, and 1,2-cycloalkenylene group and a hydrocarbon-substituted-1,2-cycloalkenylene group are more preferable.

When Z is the aromatic hydrocarbon group having the carbon number of 6 to 24, illustrative examples thereof include a 1,2-phenylene group, 3-methyl-1,2-phenylene group, a 3,6-dimethyl-1,2-phenylene group, a 1,2-naphthylene group, a 2,3-naphthylene group, a 5-methyl-1,2-naphthylene group, a 9,10-phenanthrylene group, and a 1,2-anthracenylene group; an aromatic hydrocarbon group having the carbon number of 6 to 12 is preferable.

When Z is the nitrogen atom-containing hydrocarbon group having the carbon number of 1 to 24, illustrative examples thereof include a 1-dimethylaminoethylene group, a 1,2-bisdimethylaminoethylene group, a 1-diethylaminoethylene group, a 2-diethylamino-1,3-propylene group, a 2-ethylamino-1,3-propylene group, a 4-dimethylamino-1,2-phenylene group, and a 4,5-bis(dimethylamino)phenylene group; a nitrogen atom-containing hydrocarbon group having the carbon number of 2 to 12 is preferable.

When Z is the oxygen atom-containing hydrocarbon group having the carbon number of 1 to 24, illustrative examples thereof include a 1-methoxyethylene group, a 2,2-dimethoxy-1,3-propanylene group, a 2-ethoxy-1,3-propanylene group, a 2-t-butoxy-1,3-propanylene group, a 2,3-dimethoxy-2,3-butylene group, and a 4-methoxy-1,2-phenylene group; an oxygen atom-containing hydrocarbon group having the carbon number of 2 to 12 is preferable.

When Z is the phosphorus-containing hydrocarbon group having the carbon number of 1 to 24, illustrative examples thereof include a 1-dimethylphosphinoethylene group, a 2,2-bis(dimethylphosphino)-1,3-propanylene group, a 2-diethylphosphino-1,3-propanylene group, a 2-t-butoxymethylphosphino-1,3-propanylene group, a 2,3-bis(diphenylphosphino)-2,3-butylene group, and a 4-methylphosphate-1,2-phenylene group; a phosphorus-containing hydrocarbon group having the carbon number of 1 to 12 is preferable.

When Z is the cyclic group such as a cycloalkylene group, a cycloalkenylene group, or an aromatic hydrocarbon group, the two oxygen atoms to which Z is bonded are joined by a carbon chain, and a bonding group in which the carbon chain is composed of two carbon atoms means that the two adjacent carbon chains in the carbon chain forming the ring is the carbon chain between the two oxygen atoms to which Z is bonded.

There is no particular restriction in the ether carbonate compound represented by the general formula (10); illustrative examples thereof include 2-methoxyethyl methyl carbonate, 2-ethoxyethyl methyl carbonate, 2-propoxyethyl methyl carbonate, 2-(2-ethoxyethyloxy)ethyl methyl carbonate, 2-benzyloxyethyl methyl carbonate, (2-methoxypropyl) methyl carbonate, 2-ethoxypropyl methyl carbonate, 2-methyl(2-methoxy)butyl methyl carbonate, 2-methyl(2-ethoxy)butyl methyl carbonate, 2-methyl(2-methoxy)pentyl methyl carbonate, 2-methyl(2-ethoxy)pentyl methyl carbonate, 1-phenyl(2-methoxy) propyl carbonate, 1-phenyl(2-ethoxy)propyl methyl carbonate, 1-phenyl(2-benzyloxy)propyl methyl carbonate, 1-phenyl(2-methoxy)ethyl methyl carbonate, 1-phenyl(2-ethoxy)ethyl methyl carbonate, 1-methyl-1-phenyl(2-methoxy)ethyl methyl carbonate, 1-methyl-1-phenyl(2-ethoxy)ethyl methyl carbonate, 1-methyl-1-phenyl(2-benzyloxy)ethyl methyl carbonate, 1-methyl-1-phenyl(2-(2-ethoxyethyloxy)ethyl methyl carbonate, 2-methoxyethyl ethyl carbonate, 2-ethoxyethyl ethyl carbonate, 1-phenyl(2-methoxy)ethyl ethyl carbonate, 1-phenyl(2-ethoxy)ethyl ethyl carbonate, 1-phenyl(2-propoxy)ethyl ethyl carbonate, 1-phenyl(2-butoxy)ethyl ethyl carbonate, 1-phenyl(2-isobutoxy)ethyl ethyl carbonate, 1-phenyl(2-(2-ethoxyethyloxy)ethyl ethyl carbonate, 1-methyl-1-phenyl(2-methoxy)ethyl ethyl carbonate, 1-methyl-1-phenyl(2-ethoxy)ethyl ethyl carbonate, 1-methyl-1-phenyl(2-propoxy)ethyl ethyl carbonate, 1-methyl-1-phenyl(2-butoxy)ethyl ethyl carbonate, 1-methyl-1-phenyl(2-isobutyloxy)ethyl ethyl carbonate, 1-methyl-1-phenyl(2-benzyloxy)ethyl ethyl carbonate, 1-methyl-1-phenyl(2-(2-ethoxyethyloxy)ethyl ethyl carbonate, 2-methoxyethyl phenyl carbonate, 2-ethoxyethyl phenyl carbonate, 2-propoxyethyl phenyl carbonate, 2-butoxyethyl phenyl carbonate, 2-isobutyloxyethyl phenyl carbonate, 2-benzyloxyethyl phenyl carbonate, 2-(2-ethoxyethyloxy)ethyl phenyl carbonate, 2-methoxyethyl p-methylphenyl carbonate, 2-ethoxyethyl p-methylphenyl carbonate, 2-propoxyethyl p-methylphenyl carbonate, 2-butoxyethyl p-methylphenyl carbonate, 2-isobutyloxyethyl p-methylphenyl carbonate, 2-benzyloxyethyl p-methylphenyl carbonate, 2-(2-ethoxyethyloxy)ethyl p-methylphenyl carbonate, 2-methoxyethyl o-methylphenyl carbonate, 2-ethoxyethyl o-methylphenyl carbonate, 2-propoxyethyl o-methylphenyl carbonate, 2-butoxyethyl o-methylphenyl carbonate, 2-isobutyloxyethyl o-methylphenyl carbonate, 2-benzyloxyethyl o-methylphenyl carbonate, 2-(2-ethoxyethyloxy)ethyl o-methylphenyl carbonate, 2-methoxyethyl o,p-dimethylphenyl carbonate, 2-ethoxyethyl o,p-dimethylphenyl carbonate, 2-propoxyethyl o,p-dimethylphenyl carbonate 2-butoxyethyl o,p-dimethylphenyl carbonate, 2-isobutyloxyethyl o,p-dimethylphenyl carbonate, 2-benzyloxyethyl o,p-dimethylphenyl carbonate, 2-(2-ethoxyethyloxy)ethyl o,p-dimethylphenyl carbonate, 2-methoxypropyl phenyl carbonate, 2-ethoxypropyl phenyl carbonate, 2-propoxypropyl phenyl carbonate, 2-butoxypropyl phenyl carbonate, 2-isobutyloxypropyl phenyl carbonate, 2-(2-ethoxyethyloxy)propyl phenyl carbonate, 2-phenyl(2-methoxy)ethyl phenyl carbonate, 2-phenyl(2-ethoxy)ethyl phenyl carbonate, 2-phenyl(2-propoxy)ethyl phenyl carbonate, 2-phenyl(2-butoxy)ethyl phenyl carbonate, 2-phenyl(2-isobutyloxy)ethyl phenyl carbonate, 2-phenyl(2-(2-ethoxyethyloxy)ethyl phenyl carbonate, 1-phenyl(2-methoxy)propyl phenyl carbonate, 1-phenyl(2-ethoxy)propyl phenyl carbonate, 1-phenyl(2-propoxy)propyl phenyl carbonate, 1-phenyl(2-isobutyloxy)propyl phenyl carbonate, 1-phenyl(2-methoxy)ethyl phenyl carbonate, 1-phenyl(2-ethoxy)ethyl phenyl carbonate, 1-phenyl(2-propoxy)ethyl phenyl carbonate, 1-phenyl(2-butoxy)ethyl phenyl carbonate, 1-phenyl(2-isobutyloxy)ethyl phenyl carbonate, 1-phenyl(2-(2-ethoxyethyloxy))ethyl phenyl carbonate, 1-methyl-1-phenyl(2-methoxy)ethyl phenyl carbonate, 1-methyl-1-phenyl(2-ethoxy)ethyl phenyl carbonate, 1-methyl-1-phenyl(2-propoxy)ethyl phenyl carbonate, 1-methyl-1-phenyl(2-butoxy)ethyl phenyl carbonate, 1-methyl-1-phenyl(2-isobutyloxy)ethyl phenyl carbonate, 1-methyl-1-phenyl(2-benzyloxy)ethyl phenyl carbonate, and 1-methyl-1-phenyl(2-(2-ethoxyethyloxy))ethyl phenyl carbonate; especially preferable are one, or two or more selected from (2-ethoxyethyl) methyl carbonate, (2-ethoxyethyl) ethyl carbonate, (2-propoxyethyl) propyl carbonate, (2-butoxyethyl) butyl carbonate, (2-butoxyethyl) ethyl carbonate, (2-ethoxyethyl) propyl carbonate, (2-ethoxyethyl) phenyl carbonate, and (2-ethoxyethyl)-p-methylphenyl carbonate. Among those described above, (2-ethoxyethyl) methyl carbonate, (2-ethoxyethyl) ethyl carbonate, and (2-ethoxyethyl) phenyl carbonate are particularly preferable.

The ether carbonate compound may be used singly or in a combination of two or more of those described above.

The polyol ester compound is, for example, at least one compound represented by the following general formula (11):

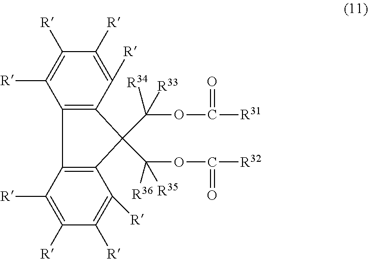

(in the formula, R³¹ and R³², which are optionally identical or different from each other, may be selected from the group consisting of a hydrogen atom, a halogen atom, and a substituted or an unsubstituted hydrocarbon group having the carbon number of 1 to 20, and R³¹ to R³⁶ contain optionally a carbon atom, a hydrogen atom, or at least one heteroatom substituting both, in which the heteroatom is selected from the group consisting of a nitrogen atom, an oxygen atom, a sulfur atom, a silicon atom, a phosphorus atom, and a halogen atom, and all of R³³, R³⁴, R³⁵, and R³⁶ are not a hydrogen atom at the same time. R′, which are optionally identical or different from each other, represent a hydrogen atom, a halogen atom, a linear or a branched alkyl group having the carbon number of 1 to 20, a cycloalkyl group having the carbon number of 3 to 20, an aryl group having the carbon number of 6 to 20, an alkaryl group having the carbon number of 7 to 20, or an aralkyl group having the carbon number of 7 to 20).

The polyol ester compound represented by the general formula (11) is preferably used when selected from the compounds in which R³¹ and R³² are selected from the group consisting of: a benzene ring-containing group in which a carbon atom on the benzene ring is optionally substituted by a heteroatom of an oxygen atom and/or a nitrogen atom or substituted by an alkyl group or an alkoxy group or a halogen atom; an alkenyl group such as a vinyl group, a propenyl or a styryl group, or a substituted alkenyl group substituted with a phenyl group; and an alkyl group such as a methyl group, an ethyl group, and a propyl group; and at least one of R³³ and R³⁴, and R³⁵ and R³⁶ are selected from the group consisting of: a halogen-substituted or halogen-unsubstituted linear or a branched alkyl group having the carbon number of 1 to 10, a cycloalkyl group having the carbon number of 3 to 10, an aryl group having the carbon number of 6 to 10, an alkrayl group having the carbon number of 7 to 10, and an aralkyl group having the carbon number of 7 to 10;
especially preferable are polyol ester compounds such as 9,9-bis(benzoyloxymethyl)fluorene, 9,9-bis((m-methoxybenzoyloxy)methyl)fluorene, 9,9-bis((m-chlorobenzoyloxy)methyl)fluorene, 9,9-bis((p-chlorobenzoyloxy)methyl)fluorene, 9,9-bis(cinnamoyloxymethyl)fluorene, 9-(benzoyloxymethyl)-9-(propionyloxymethyl)fluorene, 9,9-bis(propionyloxymethyl)fluorene, 9,9-bis(acryloyloxymethyl)fluorene, 9,9-bis(pivalyloxymethyl)fluorene, and 9,9-fluorenylmethanol dibenzoate.

(a2) The second internal electron-donating compound-containing solid catalyst component for olefin polymerization contains as an essential component the second internal electron-donating compound as the internal electron-donating compound; however, this may further contain an internal electron-donating compound other than the second internal electron-donating compound as the internal electron-donating compound (hereinafter, this is referred to as “other internal electron-donating compound”, as appropriate).

The other internal electron-donating compound according to (a2) the second internal electron-donating compound-containing solid catalyst component for olefin polymerization is the same as the other internal electron-donating compound according to (a1) the first internal electron-donating compound-containing solid catalyst component for olefin polymerization.

In (a2) the second internal electron-donating compound-containing solid catalyst component for olefin polymerization, the content of the second internal electron-donating compound in the total content of the component in terms of the solid content is from 10.0 to 20.0% by mass, preferably from 12.0 to 20.0% by mass, and more preferably from 13.0 to 18.0% by mass. When the content of the second internal electron-donating compound in the total content of the component in terms of the solid content is within the above-mentioned range, the catalyst can exhibit good polymerization performance, including stereo-regularity and flowability such as MFR of the resulting polymer.

In (a2) the second internal electron-donating compound-containing solid catalyst component for olefin polymerization, the content of the titanium atom in the total content of the component in terms of the solid content is from 1.0 to 6.0% by mass, preferably from 1.5 to 5.5% by mass, and more preferably from 2.0 to 5.0% by mass.

In (a2) the second internal electron-donating compound-containing solid catalyst component for olefin polymerization, the content of the halogen atom in the total content of the component in terms of the solid content is from 50.0 to 70.0% by mass, preferably from 55.0 to 68.0% by mass, and more preferably from 58.0 to 67.0% by mass.

In (a2) the second internal electron-donating compound-containing solid catalyst component for olefin polymerization, the content of the magnesium atom in the total content of the component in terms of the solid content is from 15.0 to 25.0% by mass, preferably from 16.0 to 23.0% by mass, and more preferably from 16.0 to 22.0% by mass.

(a2) The second internal electron-donating compound-containing solid catalyst component for olefin polymerization is preferably the one that is prepared by contacting the above-mentioned dialkoxymagnesium, titanium halide compound, and second internal electron-donating compound in the presence of an inert organic solvent.

The inert organic solvent according to (a2) the second internal electron-donating compound-containing solid catalyst component for olefin polymerization is the same as the inert organic solvent according to (a1) the first internal electron-donating compound-containing solid catalyst component for olefin polymerization.

(a2) The second internal electron-donating compound-containing solid catalyst component for olefin polymerization may be suitably produced by the production method of (a2) the second internal electron-donating compound-containing solid catalyst component for olefin polymerization, as described hereunder.

Then, the production method of (a2) the second internal electron-donating compound-containing solid catalyst component for olefin polymerization will be described.

An example of the method for producing (a2) the second internal electron-donating compound-containing solid catalyst component for olefin polymerization may include a method for obtaining (a2) the second internal electron-donating compound-containing solid catalyst component for olefin polymerization, in which the raw material component as the source of magnesium, the raw material component as the source of titanium and halogen, and the second internal electron-containing compound, which is the internal electron-donating compound, are brought into mutual contact in an organic solvent to cause the reaction. Specifically, the method thereof may include a method in which a dialkoxymagnesium, which is the raw material component as the source of magnesium, a tetravalent titanium halide compound, which is the raw material component as the source of titanium and halogen, and the internal electron-donating compound including the second internal electron-donating compound are brought into mutual contact to obtain (a2) the second internal electron-donating compound-containing solid catalyst component for olefin polymerization.

The method for producing (a2) the second internal electron-donating compound-containing solid catalyst component for olefin polymerization is the same as the method for producing (a1) the first internal electron-donating compound-containing solid catalyst component for olefin polymerization, except that, as the internal electron-donating compound to be used, the first internal electron-donating compound is replaced by the second internal electron-donating compound, in the production method of (a1) the first internal electron-donating compound-containing solid catalyst component for olefin polymerization.

The ratio of the amount of each component to be used in the production of (a2) the second internal electron-donating compound-containing solid catalyst component for olefin polymerization varies depending on the preparation method, so that this may not be generally specified. For example, to 1 mole of the magnesium compound, the ratio of the second internal electron-donating compound is preferably from 0.01 to 10 moles, more preferably from 0.01 to 1 mole, and still more preferably from 0.02 to 0.6 moles; the ratio of the tetravalent titanium halide compound is preferably from 0.5 to 100 moles, more preferably from 0.5 to 50 moles, and still more preferably from 1 to 10 moles; and the ratio of the inert organic solvent is preferably from 0.001 to 500 moles, more preferably from 0.001 to 100 moles, and especially preferably from 0.005 to 10 moles.

In the preparation method described above, in addition to the second internal electron-donating compound, other internal electron-donating compound may be used in combination with this. Further, the afore-mentioned contact may be conducted in the presence of other reaction reagent such as silicon, phosphorus, aluminum, as well as a surfactant.

In the production method of (a2) the second internal electron-donating compound-containing solid catalyst component for olefin polymerization, a suitable embodiment of (a2) the second internal electron-donating compound-containing solid catalyst component for olefin polymerization to be obtained has already been explained in detail in the description of (a2) the second internal electron-donating compound-containing solid catalyst component for olefin polymerization.

In the olefin polymerization catalyst according to the first embodiment of the present invention, the mass ratio (A/B) of the content (A) of the first internal electron-donating compound in (a1) the first internal electron-donating compound-containing solid catalyst component for olefin polymerization to the content (B) of the second internal electron-donating compound in (a2) the second internal electron-donating compound-containing solid catalyst component for olefin polymerization is preferably from 1/99 to 50/50, and more preferably from 5/95 to 15/85. When the mass ratio (A/B) is within the above-mentioned range, a polymer that is superior in both a flexural modulus and an impact resistance may be obtained by polymerization by a smaller use amount of hydrogen than before.

The olefin polymerization catalyst according to the first embodiment of the present invention contains (II) an organoaluminum compound.

In the olefin polymerization catalyst according to the first embodiment of the present invention, (II) the organoaluminum compound is an organoaluminum compound represented by the following general formula (4):

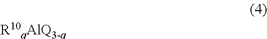

(in the formula, R¹⁰ represents an alkyl group having the carbon number of 1 to 6, Q is a hydrogen atom or a halogen atom, and q represents the number 0<q≤3, in which when there exists a plurality of R¹⁰, the plural R¹⁰ are optionally identical or different from each other, and when there are a plurality of Q, the plural Q are optionally identical or different from each other).

In the organoaluminum compound represented by the general formula (4), q represents the number 0<q≤3, and specifically q is 1, 2, or 3.

Specific example of (JJ) the organoaluminum compound may include one or more compounds selected from: trialkylaluminum such as triethylaluminum, triisopropylaluminum, tri-n-butylaluminum, tri-n-hexylaluminum, and triisobutylaluminum; alkylaluminum halides such as diethylaluminum chloride and diethylaluminum bromide; and diethylaluminum hydride. Among these, one or more compounds selected from an alkylaluminum halide such as diethylaluminum chloride, as well as trialkylaluminum such as triethylaluminum, tri-n-butylaluminum, and triisobutylaluminum is preferable. One or more compounds selected from triethylaluminum and triisobutylaluminum are more preferable.

The olefin polymerization catalyst according to the first embodiment of the present invention includes, as (III) the external electron-donating compound, at least an alkoxysilane compound represented by the general formula (1) and an aminoalkoxysilane compound represented by the general formula (2).

The olefin polymerization catalyst according to the first embodiment of the present invention contains, as the external electron-donating compound, one or more compounds selected from alkoxysilane compounds represented by the following general formula (1):

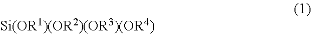

(in the formula, R¹, R², R³, and R⁴, all of which are optionally identical or different from each other, represent a linear alkyl group having the carbon number of 1 to 8, or a branched alkyl group having the carbon number of 3 to 8).

In the alkoxysilane compound represented by the general formula (1), R¹, R², R³, and R⁴, all of which are optionally identical or different from each other, are a linear or a branched alkyl group having the carbon number of 1 to 8, and preferably the carbon number of 1 to 4.

When R¹, R², R³, and R⁴ are a linear or a branched alkyl group having the carbon number of 1 to 4, specifically, the alkyl group can include a methyl group, an ethyl group, an n-propyl group, an isopropyl group, an n-butyl group, and an isobutyl group.

There is no particular restriction in the alkoxysilane compound represented by the general formula (1); illustrative examples thereof include tetramethoxysilane, tetraethoxysilane, tetra-n-propoxysilane, tetraisopropoxysilane, tetra-n-butoxysilane, and tetraisobutoxysilane; among these, tetraethoxysilane and tetra-n-propoxysilane are preferable.

The olefin polymerization catalyst according to the first embodiment of the present invention contains, as the external electron-donating compound, one or more compounds selected from aminoalkoxysilane compounds represented by the following general formula (2):

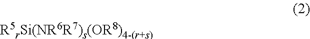

(in the formula, r is 0 to 2, s is 1 to 3, and r+s is 1 to 3. R⁵, which optionally contains a heteroatom, represents any group selected from a linear or a branched alkyl group having the carbon number of 1 to 12, a substituted or an unsubstituted cycloalkyl group, a phenyl group, an allyl group, and an aralkyl group. R⁶ and R⁷, which are optionally identical or different from each other and optionally contain a heteroatom, represent a hydrogen atom or any group selected from a linear or a branched alkyl group having the carbon number of 1 to 12, a substituted or an unsubstituted cycloalkyl group, a phenyl group, an allyl group, and an aralkyl group. R⁶ and R⁷ are optionally combined to form a ring shape, and R⁶ and R⁷ are optionally identical or different from each other. R⁸, which optionally contains a heteroatom, represents any group selected from an alkyl group having the carbon number of 1 to 12, a cycloalkyl group, a phenyl group, a vinyl group, an allyl group, and an aralkyl group. When R⁸ is plural, they are optionally identical or different from each other).

In the aminoalkoxysilane compound represented by the general formula (2), R⁵ is a linear alkyl group having the carbon number of 1 to 12, a branched alkyl group having the carbon number of 3 to 12, a substituted or unsubstituted cycloalkyl group, a phenyl group, an allyl group, and an aralkyl group; preferably any group selected from a linear alkyl group having the carbon number of 1 to 8, a branched alkyl group having the carbon number of 3 to 12, a substituted or an unsubstituted cycloalkyl group having the carbon number of 3 to 12, and an aromatic hydrocarbon group having the carbon number of 6 to 20, optionally containing a heteroatom.

In the aminoalkoxysilane compound represented by the general formula (2), R⁶ and R⁷, which are optionally identical or different from each other, are any group selected from a hydrogen atom, a linear alkyl group having the carbon number of 1 to 12, preferably a linear alkyl group having the carbon number of 1 to 6, a branched alkyl group having the carbon number of 3 to 6, a substituted or an unsubstituted cycloalkyl group, and an aromatic hydrocarbon group having the carbon number of 6 to 20, optionally containing a heteroatom. R⁶ and R⁷ may be bonded to form a ring shape.

R⁵ may include a methyl group, an ethyl group, an n-propyl group, an isopropyl group, an n-butyl group, an isobutyl group, a neopentyl group, a cyclopentyl group, an n-hexyl group, a cyclohexyl group, and a 2-ethylhexyl group.

In the aminoalkoxysilane compound represented by the general formula (2), R⁶ and R⁷, which are optionally identical or different from each other, are a linear alkyl group having the carbon number of 1 to 12, preferably a linear alkyl group having the carbon number of 1 to 6, or a branched alkyl group having the carbon number 3 to 6.

R⁶ and R⁷ may include a methyl group, an ethyl group, an n-propyl group, an isopropyl group, an n-butyl group, an isobutyl group, an n-pentyl group, a neopentyl group, and an n-hexyl group.

In the aminoalkoxysilane compound represented by the general formula (2), R⁸ is any group selected from an alkyl group having the carbon number of 1 to 12, preferably a linear alkyl group having the carbon number of 1 to 6, or a branched alkyl group having the carbon number 3 to 6, a cycloalkyl group having the carbon number of 3 to 6, a vinyl group, and an aromatic hydrocarbon group having the carbon number of 6 to 12, optionally containing a heteroatom. When R⁸ is plural, they are optionally identical or different from each other.

R⁸ may include a methyl group, an ethyl group, an n-propyl group, an isopropyl group, an n-butyl group, an isobutyl group, an n-pentyl group, a neopentyl group, an n-hexyl group, a cyclopentyl group, a cyclohexyl group, a vinyl group, and a phenyl group.

In the aminoalkoxysilane compound represented by the general formula (2), r is 0 to 2, preferably 1 to 2, and s is 1 to 3, preferably 1 to 2. Also, r+s is 1 to 3, preferably 1 to 2.

Illustrative examples of the aminoalkoxysilane compound represented by the general formula (2) include an alkylamino trialkoxysilane with r=0 and s=1, a bis(alkylamino)dialkoxysilane with r=0 and s=2, a tris(alkylamino)alkoxysilane with r=0 and s=3, an alkyl (alkylamino)dialkoxysilane with r=1 and s=1, an alkyl bis(alkylamino)alkoxysilane with r=1, s=2, and a dialkyl(alkylamino)alkoxysilane with r=2, s=1;
preferably a monoalkylaminotrialkoxysilane where r=0, s=1 and one of R⁶ and R⁷ is a hydrogen atom, or a dialkylamino trialkoxysilane where r=0, s=1 and both R⁶ and R⁷ are selected from a linear or a branched alkyl group having the carbon number of 1 to 12, a substituted or an unsubstituted cycloalkyl group, a phenyl group, an allyl group, and an aralkyl group;
more preferably a dialkylaminotrialkoxysilane such as dimethylaminotriethoxysilane, diethylaminotrimethoxysilane, diethylaminotriethoxysilane, diethylaminotri-n-propoxysilane, di-n-propylaminotriethoxysilane, methyl-n-propylaminotriethoxysilane, methyl-t-butylaminotriethoxysilane, ethyl-n-propylaminotriethoxysilane, ethylisopropylaminotriethoxysilane, and methylethylaminotriethoxysilane; and
especially preferably dimethylaminotriethoxysilane, diethylaminotrimethoxysilane, and diethylaminotriethoxysilane.

In the olefin polymerization catalyst according to the first embodiment of the present invention, the molar ratio (Y/X) of the content (Y) of the alkoxysilane compound represented by the general formula (1) to the content (X) of the aminoalkoxysilane compound represented by the general formula (2) is preferably from 1/99 to 70/30, and more preferably from 10/90 to 50/50. The molar ratio (Y/X) within the above range results in the external donor mixture that exhibits a high activity and a high copolymerization performance.

The olefin polymerization catalyst according to the first embodiment of the present invention includes (I) (a1) the first internal electron-donating compound-containing solid catalyst component for olefin polymerization and (a2) the second internal electron-donating compound-containing solid catalyst component for olefin polymerization, (II) the organoaluminum compound, and at least the alkoxysilane compound represented by the general formula (1) and the aminoalkoxysilane compound represented by the general formula (2) as (III) the external electron-donating compounds, in other words, the contact product of these compounds.

The olefin polymerization catalyst according to the first embodiment of the present invention may be the catalyst that is prepared by contacting, in the absence of an olefin, (I) (a1) the first internal electron-donating compound-containing solid catalyst component for olefin polymerization and (a2) the second internal electron-donating compound-containing solid catalyst component for olefin polymerization, (II) the organoaluminum compound, and at least the alkoxysilane compound represented by the general formula (1) and the aminoalkoxysilane compound represented by the general formula (2) as (III) the external electron-donating compound, or the catalyst that is obtained by contacting these compounds in the presence of an olefin (in a polymerization system), which is going to be described later.

In the olefin polymerization catalyst according to the first embodiment of the present invention, there is no particular restriction in the content ratio of each component as long as it does not adversely affect the advantageous effects of the present invention. In general, the content of (II) the organoaluminum compound relative to 1 mole of total amount of the titanium atom in (I) (a1) the first internal electron-donating compound-containing solid catalyst component for olefin polymerization and the titanium atom in (a2) the second internal electron-donating compound-containing solid catalyst component for olefin polymerization is preferably from 1 to 2000 moles, and more preferably from 50 to 1000 moles. Also, in the olefin polymerization catalyst according to the first embodiment of the present invention, the total mole number of the alkoxysilane compound represented by the general formula (1) and the aminoalkoxysilane compound represented by the general formula (2), which are (III) the external electron-donating compounds, relative to 1 mole of (II) the organoaluminum compound is preferably from 0.002 to 10.000 moles, more preferably from 0.010 to 2.000 moles, and still more preferably from 0.010 to 0.500 moles.

The olefin polymerization catalyst according to a second embodiment of the present invention includes as (I) the solid catalyst component for olefin polymerization, at least (b) a first internal electron-donating compound- and a second internal electron-donating compound-containing solid catalyst component for olefin polymerization.

(b) The first and second internal electron-donating compound-containing solid catalyst component for olefin polymerizations that are related to the olefin polymerization catalyst according to the second embodiment of the present invention are the solid catalyst component for olefin polymerization containing at least magnesium, titanium, halogen, and as the internal electron-donating compound, at least the first internal electron-donating compound and the second internal electron-donating compound. (b) The first and second internal electron-donating compound-containing solid catalyst component for olefin polymerizations are the solid catalyst component having both the first internal electron-donating compound and the second internal electron-donating compound supported in the solid catalyst component.

(b) The first and second internal electron-donating compound-containing solid catalyst component for olefin polymerizations include a contact-reaction product obtained by the reaction in which a raw material component as the source of magnesium, a raw material component as the source of titanium and halogen, and the first internal electron-donating compound and the second internal electron-donating compound, which are the internal electron-donating compounds, are brought into mutual contact in an organic solvent. Specifically, the solid catalyst component for olefin polymerization includes a contact-reaction product in which as the raw material components, a dialkoxymagnesium is used as the source of magnesium and a tetravalent titanium halide compound is used as the source of titanium and halogen, and then, these are brought into mutual contact with the internal electron-donating compounds including the first internal electron-donating compound and the second internal electron-donating compound.

In (b) the first and second internal electron-donating compound-containing solid catalyst component for olefin polymerizations, the dialkoxymagnesium, i.e., the raw material component as the source of magnesium, is the same as the dialkoxymagnesium compound that is the raw material component as the source of magnesium in (a1) the first internal electron-donating compound-containing solid catalyst component for olefin polymerization.

In (b) the first and second internal electron-donating compound-containing solid catalyst component for olefin polymerizations, the tetravalent titanium halide compound, i.e., the raw material component as the source of titanium and halogen, is the same as the tetravalent titanium halide compound that is the raw material component as the source of titanium and halogen in (a1) the first internal electron-donating compound-containing solid catalyst component for olefin polymerization.

The first internal electron-donating compound according to (b) the first and second internal electron-donating compound-containing solid catalyst component for olefin polymerizations is the same as the first internal electron-donating compound according to (a1) the first internal electron-donating compound-containing solid catalyst component for olefin polymerization. The second internal electron-donating compound according to (b) the first and second internal electron-donating compound-containing solid catalyst component for olefin polymerizations is the same as the second internal electron-donating compound according to (a2) the second internal electron-donating compound-containing solid catalyst component for olefin polymerization.

The first internal electron-donating compound and the second internal electron-donating compound each may be used singly or in combination of two or more compounds.

(b) The first and second internal electron-donating compound-containing solid catalyst component for olefin polymerizations contains as an essential component the first internal electron-donating compound and the second internal electron-donating compound as the internal electron-donating compound. The component, however, may further contain an internal electron-donating compound as the internal electron-donating compound other than the first internal electron-donating compound and the second internal electron-donating compound (hereinafter, this is referred to as “other internal electron-donating compound”, as appropriate).

The other internal electron-donating compound according to (b) the first and second internal electron-donating compound-containing solid catalyst component for olefin polymerizations is the same as the other internal electron-donating compound according to (a1) the first internal electron-donating compound-containing solid catalyst component for olefin polymerization.

In (b) the first and second internal electron-donating compound-containing solid catalyst component for olefin polymerizations, the content of the first internal electron-donating compound in the total content of the component in terms of the solid content is from 10.0 to 20.0% by mass, preferably from 12.0 to 20.0% by mass, and more preferably from 13.0 to 18.0% by mass. When the content of the first internal electron-donating compound in the total content of components in terms of the solid content is within the above range, it is possible to produce a large amount of a high molecular weight polymer when polymerized, resulting in a high flexural modulus.

In (b) the first and second internal electron-donating compound-containing solid catalyst component for olefin polymerizations, the content of the second internal electron-donating compound in the total content of the component in terms of the solid content is from 10.0 to 20.0% by mass, preferably from 12.0 to 20.0% by mass, and more preferably from 13.0 to 18.0% by mass. When the content of the second internal electron-donating compound in the total content of components in terms of the solid content is within the above range, a high MFR can be obtained with a relatively low hydrogen amount when polymerized, making the polymer to have a high flowability.

In (b) the first and second internal electron-donating compound-containing solid catalyst component for olefin polymerizations, the content of the titanium atom in the total content of the component in terms of the solid content is from 0.5 to 6.0% by mass, preferably from 1.0 to 5.0% by mass, and more preferably from 1.5 to 4.0% by mass.

In (b) the first and second internal electron-donating compound-containing solid catalyst component for olefin polymerizations, the content of the halogen atom in the total content of the component in terms of the solid content is from 50.0 to 70.0% by mass, preferably from 55.0 to 68.0% by mass, and more preferably from 58.0 to 67.0% by mass.

In (b) the first and second internal electron-donating compound-containing solid catalyst component for olefin polymerizations, the content of the magnesium atom in the total content of the component in terms of the solid content is from 15.0 to 25.0% by mass, preferably from 16.0 to 23.0% by mass, and more preferably from 16.0 to 22.0% by mass.

(b) The first and second internal electron-donating compound-containing solid catalyst component for olefin polymerizations are preferably the one that is prepared by contacting the above-mentioned dialkoxymagnesium, titanium halide compound, first internal electron-donating compound, and second internal electron-donating compound in the presence of an inert organic solvent.

The inert organic solvent according to (b) the first and second internal electron-donating compound-containing solid catalyst component for olefin polymerizations is the same as the inert organic solvent according to (a1) the first internal electron-donating compound-containing solid catalyst component for olefin polymerization.

(b) The first and second internal electron-donating compound-containing solid catalyst component for olefin polymerizations may be suitably produced by the production method of (b) the first and second internal electron-donating compound-containing solid catalyst component for olefin polymerizations, as described hereunder.

Then, the production method of (b) the first and second internal electron-donating compound-containing solid catalyst component for olefin polymerizations will be described.

An example of the method for producing (b) the first and second internal electron-donating compound-containing solid catalyst component for olefin polymerizations may include the method for obtaining (b) the first and second internal electron-donating compound-containing solid catalyst component for olefin polymerizations, in which the raw material component as the source of magnesium, the raw material component as the source of titanium and halogen, and the first internal electron-donating compound and the second internal electron-donating compound, which are the internal electron-donating compounds, are brought into mutual contact in an organic solvent to cause the reaction. Specifically, the method may include the method in which a dialkoxymagnesium, which is the raw material component as the source of magnesium, a tetravalent titanium halide compound, which is the raw material component as the source of titanium and halogen, and the internal electron-donating compounds including the first internal electron-donating compound and the second internal electron-donating compound are brought into mutual contact to obtain (b) the first and second internal electron-donating compound-containing solid catalyst component for olefin polymerizations.

The method for producing (b) the first and second internal electron-donating compound-containing solid catalyst component for olefin polymerizations is the same as the method for producing (a1) the first internal electron-donating compound-containing solid catalyst component for olefin polymerization, except that, in the production method of (a1) the first internal electron-donating compound-containing solid catalyst component for olefin polymerization, as the internal electron-donating compound to be used, the first internal electron-donating compound and the second internal electron-donating compound are used instead of the first internal electron-donating compound, and the raw materials such as a dialkoxymagnesium that is the raw material component as the source of magnesium and a tetravalent titanium halide compound that is the raw material component as the source of titanium and halogen are brought into mutual contact with the first internal electron-donating compound and the second internal electron-donating compound. In the production method of (b) the first and second internal electron-donating compound-containing solid catalyst component for olefin polymerizations, the order of contacting the first internal electron-donating compound and the second internal electron-donating compound, which are the internal electron-donating compounds, is not particularly restricted, so that the first internal electron-donating compound may be contacted firstly, or the second internal electron-donating compound may be contacted firstly, or they may be contacted at the same time. However, as the reaction progresses, the more the dialkoxymagnesium is converted to magnesium chloride by the titanium halide compound, the more difficult it is for the first internal electron-donating compound to be supported on the solid catalyst component; thus, it is preferable to contact the first internal electron-donating compound firstly, followed by the second internal electron-donating compound.

The ratio of the amount of each component to be used in the production of (b) the first and second internal electron-donating compound-containing solid catalyst component for olefin polymerizations varies depending on the preparation method, so that this may not be generally specified. For example, to 1 mole of the magnesium compound, the ratio of the total moles of the first internal electron-donating compound and the second internal electron-donating compound is preferably from 0.01 to 10 moles, more preferably from 0.01 to 1 mole, and still more preferably from 0.02 to 0.6 moles; the ratio of the tetravalent titanium halide compound is preferably from 0.5 to 100 moles, more preferably from 0.5 to 50 moles, and still preferably from 1 to 10 moles; and the ratio of the inert organic solvent is preferably from 0.001 to 500 moles, more preferably from 0.001 to 100 moles, and especially preferably from 0.005 to 10 moles.

In the preparation method described above, in addition to the first internal electron-donating compound and the second internal electron-donating compound, other internal electron-donating compound may be used in combination with these compounds. Further, the afore-mentioned contact may be conducted in the presence of other reaction reagent such as silicon, phosphorus, aluminum, as well as a surfactant.

In the production method of (b) the first and second internal electron-donating compound-containing solid catalyst component for olefin polymerizations, a suitable embodiment of (b) the first and second internal electron-donating compound-containing solid catalyst component for olefin polymerizations to be obtained has already been explained in detail in the description of (b) the first and second internal electron-donating compound-containing solid catalyst component for olefin polymerizations.

In the olefin polymerization catalyst according to the second embodiment of the present invention, the mass ratio (C/D) of the content (C) of the first internal electron-donating compound to the content (D) of the second internal electron-donating compound in (b) the first and second internal electron-donating compound-containing solid catalyst component for olefin polymerizations is preferably from 1/99 to 50/50, and more preferably from 5/95 to 40/60. The mass ratio (C/D) within the above range makes the olefin polymerization catalyst to exhibit a high activity and a high flexural modulus.

The olefin polymerization catalyst according to the second embodiment of the present invention contains (II) an organoaluminum compound.

(II) The organoaluminum compound relating to the olefin polymerization catalyst according to the second embodiment of the present invention is the same as (II) the organoaluminum compound relating to the olefin polymerization catalyst according to the first embodiment of the present invention.

The olefin polymerization catalyst according to the second embodiment of the present invention includes, as (III) the external electron-donating compound, at least the alkoxysilane compound represented by the general formula (1) and the aminoalkoxysilane compound represented by the general formula (2).

In the olefin polymerization catalyst according to the second embodiment of the present invention, the alkoxysilane compound represented by the general formula (1) and the aminoalkoxysilane compound represented by the general formula (2), which are used as (III) the external electron-donating compounds, are the same as the alkoxysilane compound represented by the general formula (1) and the aminoalkoxysilane compound represented by the general formula (2) used as (III) the external electron-donating compounds in the olefin polymerization catalyst according to the first embodiment of the present invention.

In the olefin polymerization catalyst according to the second embodiment of the present invention, the molar ratio (Y/X) of the content (Y) of the aminoalkoxysilane compound represented by the general formula (2) to the content (X) of the alkoxysilane compound represented by the general formula (1) is preferably from 1/99 to 70/30, and more preferably from 10/90 to 30/70. The molar ratio (Y/X) within the above range results in the external donor mixture that exhibits a high activity and a high copolymerization performance.

The olefin polymerization catalyst according to the second embodiment of the present invention is the one that includes (I) (b) the first and second internal electron-donating compound-containing solid catalyst component for olefin polymerizations, (II) the organoaluminum compound, and as (III) the external electron-donating compound, at least the alkoxysilane compound represented by the general formula (1) and the aminoalkoxysilane compound represented by the general formula (2); in other words, the catalyst is the contact product of these compounds.

The olefin polymerization catalyst according to the second embodiment of the present invention may be the catalyst that is prepared, in the absence of an olefin, by contacting (I) (b) the first and second internal electron-donating compound-containing solid catalyst component for olefin polymerizations, (II) the organoaluminum compound, and as (III) the external electron-donating compound, the alkoxysilane compound represented by the general formula (1) and the aminoalkoxysilane compound represented by the general formula (2), or the catalyst that is obtained by contacting these compounds in the presence of an olefin (in a polymerization system), which is going to be described later.

In the olefin polymerization catalyst according to the second embodiment of the present invention, there is no particular restriction in the content ratio of each component as long as it does not adversely affect the advantageous effects of the present invention. In general, the content of (II) the organoaluminum compound relative to 1 mole of the titanium atom in (I) (b) the first and second internal electron-donating compound-containing solid catalyst component for olefin polymerizations is preferably from 1 to 2000 moles, and more preferably from 50 to 1000 moles. Also, in the olefin polymerization catalyst according to the second embodiment of the present invention, the total mole number of the alkoxysilane compound represented by the general formula (1) and the aminoalkoxysilane compound represented by the general formula (2), which are (III) the external electron-donating compounds, relative to 1 mole of (II) the organoaluminum compound is preferably from 0.002 to 10.000 moles, more preferably from 0.010 to 2.000 moles, and still more preferably from 0.010 to 0.500 moles.

The olefin polymerization catalyst using the olefin polymerization solid catalyst component that uses, as the internal electron-donating compound, only a succinate diester gives a polymer having a high flexural modulus (FM), but it is necessary to increase the use amount of hydrogen in order to increase a melt flowability (melt flow rate: MFR).

The inventors of the present invention have found that when the olefin polymerization catalyst containing the succinate diester compound as the internal electron-donating compound and the alkoxysilane compound represented by the general formula (1) as the external electron-donating compound are used in the solid catalyst component for olefin polymerization at the time of olefin polymerization, a polymer having a high melt flow rate (MFR) can be obtained even when the use amount of hydrogen is small. Based on this finding, the inventors of the present invention have found in the olefin polymerization catalyst according to the present invention that because by using the succinate diester compound as the internal electron-donating compound in the solid catalyst component for olefin polymerization, an olefin polymer having a wide molecular weight distribution with a very high molecular weight can be formed; thus, by simultaneously using the second internal electron-donating compound as the internal electron-donating compound, it becomes possible to increase an activity and an effect of the external donor while increasing the flexural modulus (FM) of the resulting olefin polymer. In the olefin polymerization catalyst according to the present invention, with designing the solid catalyst component for olefin polymerization in the way as described above, when as the external electron-donating compounds the aminoalkoxysilane compound represented by the general formula (2) having a high polymerization activity and a high regularity and the alkoxysilane compound represented by the general formula (1) are used in combination, an olefin polymer having a high melt flowability (MFR) can be obtained even with a small use amount of hydrogen.

The method for producing an olefin polymer according to the present invention is characterized in that an olefin is polymerized using the olefin polymerization catalyst according to the present invention, for example, the olefin polymerization catalyst according to the first embodiment of the present invention, or the olefin polymerization catalyst according to the second embodiment of the present invention.

In the method for producing an olefin polymer according to the present invention, the polymerization of an olefin may include any of homo-polymerization and copolymerization.

In the method for producing an olefin polymer according to the present invention, the olefin used for polymerization may be at least one olefin selected from ethylene, propylene, 1-butene, 1-pentene, 4-methyl-1-pentene, and vinyl cyclohexane. Among them, at least one olefin selected from ethylene, propylene, and 1-butene are preferable; propylene is more preferable.

When the olefin is propylene, the polymerization thereof may be a homo-polymerization of propylene or a copolymerization of propylene with other α-olefin.

Examples of the olefin that is copolymerized with propylene include at least one olefin selected from ethylene, 1-butene, 1-pentene, 4-methyl-1-pentene, and vinylcyclohexane.

When the olefin polymerization catalyst according to the present invention is prepared in the presence of an olefin (in the polymerization system), there is no particular restriction in the ratio of the amount of each component to be used as long as it does not adversely affect the advantageous effects of the present invention. In general, it is preferable to contact (II) the organoaluminum compound of 1 to 2000 moles, and more preferably 50 to 1000 moles with 1 mole of the titanium atom in (I) the solid catalyst component for olefin polymerization described above. Also, it is preferable that 0.002 to 10.000 moles of (III) the external electron-donating compound is contacted with 1 mole of (II) the organoaluminum compound; this is more preferably from 0.010 to 2.000 moles, and still more preferably from 0.010 to 0.500 moles.

Although the order of the contact of each component that constitutes the olefin polymerization catalyst is arbitrary, it is preferable to charge firstly (II) the organoaluminum compound into the polymerization system, followed by charging and contacting (III) the external electron-donating compound when (III) the external electron-donating compound is used, and then further charging and contacting (I) the solid catalyst component for olefin polymerization.

The method for producing an olefin polymer according to the present invention may be carried out in the presence or absence of an organic solvent.

An olefin monomer such as propylene may be used in any of a gaseous state and a liquid state. The polymerization temperature is preferably 200° C. or less, and more preferably 100° C. or less. The pressure at the time of polymerization is preferably 10 MPa or less, and more preferably 5 MPa or less. Polymerization of an olefin can be carried out by any of a continuous polymerization method and a batch polymerization method. The polymerization reaction may be carried out in one stage or in two stages or more.

In addition, in the polymerization of the olefin using the olefin polymerization catalyst according to the present invention (also called main polymerization), it is preferable to conduct prepolymerization prior to the main polymerization in order to further enhance the properties such as a catalytic activity, a stereo-regularity, and a particle property of the resulting polymer. In the prepolymerization, the same olefin as the olefin to be used in the main polymerization, or a monomer such as styrene can be used.

At the time of prepolymerization, the contacting order of each component in the olefin polymerization catalyst and the monomer (olefin) is arbitrary. However, in the prepolymerization system set in an inert gas or in an olefin gas atmosphere, it is preferable that (II) the organoaluminum compound is charged firstly, then (I) the solid catalyst component for olefin polymerization according to the present invention is charged and contacted, followed by charging and contacting solely an olefin such as propylene or a mixture of an olefin such as propylene with at least one other olefin.

At the prepolymerization described above, in the case when (III) the external electron-donating compound is further charged into the prepolymerization system, it is preferable that (II) the organoaluminum compound is charged firstly into the prepolymerization system set in an inert gas or in an olefin gas atmosphere, then (III) the external electron-donating compound is charged and contacted, followed by contacting (I) the solid catalyst component for olefin polymerization according to the present invention, and then further contacting solely an olefin such as propylene, or a mixture an olefin such as propylene with at least one other olefin.

In the method for producing an olefin polymer according to the present invention, the polymerization method can include a slurry polymerization method using an inert hydrocarbon compound solvent such as cyclohexane and heptane, a bulk polymerization method using a solvent such as a liquefied propylene, and a vapor phase polymerization method using substantially no solvent; among these, the bulk polymerization method and the vapor phase polymerization method are preferable.

In the case of copolymerization of propylene and other α-olefin monomer, typically there are random copolymerization in which propylene and a small amount of ethylene as a comonomer are polymerized in one stage, and a so-called propylene-ethylene block copolymerization in which propylene is solely polymerized in the first stage (first polymerization reactor) and then propylene is copolymerized with other α-olefin such as ethylene in the second stage (second polymerization reactor) or in multiple stages (multi-stage polymerization reactor). Here, the block copolymerization of propylene and other α-olefin is preferable.

The block copolymer obtained by the block copolymerization is a polymer containing segments of continuously varying monomer compositions of two types or more, in which two or more polymer chains (segments) having different primary structures such as a monomer species, a comonomer species, a comonomer composition, a comonomer content, a comonomer arrangement, and a steric regularity are bonded in one molecular chain.

In the method for producing an olefin polymer according to the present invention, the block copolymerization reaction of propylene with other α-olefin is usually carried out in the presence of the olefin polymerization catalyst according to the present invention in the first half stage by contacting solely propylene, or propylene and a small amount of an α-olefin (e.g., ethylene), followed by contacting propylene with the α-olefin (e.g., ethylene) in the second half stage. The polymerization reaction may be carried out by a multi-stage reaction, in which the polymerization reaction in the first half stage may be repeated multiple times, or the polymerization reaction in the second half stage may be repeated multiple times.

In the block copolymerization reaction of propylene with other α-olefin, specifically, it is preferable to carry out the polymerization in such a way that in the first half stage the polymerization is carried out with controlling the polymerization temperature and time so as to result in the ratio of the polypropylene moiety (in the copolymer finally obtained) from 20 to 90% by mass, then in the second half stage, propylene as well as ethylene or other α-olefin are charged so as to result in the ratio of a rubber moiety such as an ethylene-propylene rubber (EPR) from 10 to 80% by mass (in the copolymer finally obtained).

The polymerization temperatures in both the first half stage and the second half stage are preferably 200° C. or less, more preferably 100° C. or less, still more preferably from 65° C. to 80° C., and further still more preferably from 75 to 80° C. The pressure at the time of the polymerization is preferably 10 MPa or less, more preferably 6 MPa or less, and still more preferably 5 MPa or less.

In the copolymerization reaction, any of a continuous polymerization method and a batch polymerization method may be used, and the polymerization reaction may be conducted in a one stage or two stages or more.

The polymerization time (residence time in the reactor) is preferably from 1 minute to 5 hours in each polymerization stage of the first half stage and the second half stage, or in the continuous polymerization, too.

The polymerization method may include a slurry polymerization method using an inert hydrocarbon compound solvent such as cyclohexane and heptane, a bulk polymerization method using a solvent such as liquefied propylene, and a vapor phase polymerization method substantially not using a solvent may be mentioned. Among these, the bulk polymerization method and the vapor phase polymerization method are preferable.

According to the present invention, it is possible to provide the method for producing an olefin polymer that is able to produce an olefin polymer that has a high flexural modulus and a high melt flowability even with a small use amount of hydrogen.

In the method for producing an olefin polymer according to the present invention, a hydrogen gas and an olefin are charged with a ratio such that the melt flowability (MFR) of the propylene polymer obtained in the homo-stage polymerization will be 350 g/10-minutes or less. When the hydrogen gas and olefin are charged with the ratio as mentioned above, an olefin polymer having a suitable melt flowability (MFR) may be obtained.

The melt flow rate (MFR) of the olefin homopolymer obtained with the method for producing an olefin polymer according to the present invention may be chosen as appropriate in accordance with the use thereof. The melt flow rate is, for example, from 0.1 to 1000 g/10-minutes, preferably from 10 to 500 g/10-minutes, and more preferably from 50 to 350 g/10-minutes.

Here, the melt flow rate (MFR) in this specification means the value measured by the method in accordance with ASTM D 1238 and JIS K 7210.

In this specification, the flexural modulus (FM) of an olefin polymer means the value (unit: MPa) obtained by the method described below. Namely, the injection-molded test piece of the olefin polymer, which has been mixed with a nucleating agent (1000 ppm of sodium benzoate), having the thickness of 4.0 mm, the width of 10.0 mm, and the length of 80.0 mm is prepared at the molding temperature of 200° C. and the die temperature of 40° C. using NEX30III3EG manufactured by Nissei Plastic Industrial Co., Ltd., and the flexural modulus (FM) of the test piece is measured at the atmospheric temperature of 23° C. by the method in accordance with JIS K7171.

### EXAMPLES

Next, the present invention will be more specifically explained by means of Examples; but these are mere examples, not restricting the present invention.

### (Production Example 1) Synthesis of (1) Solid Catalyst Component for Olefin Polymerization Containing Succinate Diester

By using diethyl diisopropylsuccinate, i.e., the succinate diester compound serving as the internal electron-donating compound, the solid catalyst component for olefin polymerization was prepared by the method described below.
(i) Into a 500-mL flask equipped with a stirrer and completely purged with a nitrogen gas inside thereof, 60 mL (545.8 mmoles) of titanium tetrachloride and 75 mL of toluene were charged to form a mixed solution.
(ii) Next, a suspension solution obtained from 30.0 g (262.2 mmoles) of diethoxymagnesium, 90 mL of toluene, and 4.5 mL (16.8 mmoles) of diethyl diisopropylsuccinate was charged into the above-prepared mixed solution while keeping its liquid temperature at −6° C.
(iii) The temperature of the resulting initial contact product-containing solution was raised, and at 60° C. in the midway of the temperature raising, 4.5 mL (16.8 mmoles) of diethyl diisopropylsuccinate was added to the solution. After the temperature was further raised to 100° C., the reaction was carried out for 90 minutes while keeping this temperature. After completion of the reaction, the supernatant solution was withdrawn, and the first contact product, i.e., the reaction product, was washed with 225 mL of toluene at 90° C. four times.
(iv) Next, to the resulting first contact product, 150 mL of toluene and 30 mL (272.9 mmoles) of titanium tetrachloride were added; then, the temperature of the resulting mixture was raised to 115° C., at which temperature the reaction was carried out for 60 minutes. After completion of the reaction, the operation to withdraw the supernatant solution was repeated three times to obtain the final contact product.

Next, the resulting final contact product was washed with 225 mL of n-heptane at 40° C. six times, then by conducting the solid-liquid separation, the solid catalyst component ((1) the solid catalyst component for olefin polymerization containing the succinate diester compound) was obtained.

The contents of titanium and of the succinate diester compound (ID) in the solid portion obtained by the solid-liquid separation of the obtained solid catalyst component were measured to be 3.08% by mass and 19.8% by mass, respectively.

The properties of (1) the solid catalyst component thereby obtained are described in below Table.

The contents of titanium and of the diisopropyl succinate, which corresponds to the succinate diester, which is the internal electron-donating compound, and the internal electron-donating compound, in the solid catalyst component, and the physical properties thereof were measured by the methods described below.

### <Content of Titanium in Solid Catalyst Component>

The content of titanium in the solid catalyst component was measured by the method in accordance with JIS 8311-1997.

### <Content of Internal Electron-Donating Compound>

The content of the internal electron-donating compound was determined by a gas chromatography (manufactured by Shimadzu Corp., GC-2014) under the following conditions. The mole number of the internal electron-donating compound was determined from the result of the gas chromatography using a calibration curve measured in advance by using known concentrations.

### <Measurement Conditions>

Column: Capillary column (diameter of 0.32 mm, film thickness of 1.0 μm, Rxi-1 ms, manufactured by GL Sciences Inc.)
Detector: Flame Ionization Detector (FID; hydrogen flame ionization detector)
Carrier gas: Helium, flow rate of 7.0 ml/min
Measurement temperature: Vaporization chamber 280° C., column 170° C., detector 280° C.

### (Production Example 2) Synthesis of (2) Solid Catalyst Component for Olefin Polymerization Containing Phthalate Diester

By using di-n-propyl phthalate, i.e., the phthalate diester compound as the internal electron-donating compound, the solid catalyst component for olefin polymerization was prepared by the method described below.
(i) Into a 500-mL flask equipped with a stirrer and completely purged with a nitrogen gas inside thereof, 105 mL (952.0 mmoles) of titanium tetrachloride and 75 mL of toluene were charged to form a mixed solution.
(ii) Next, a suspension solution obtained from 30.0 g (262.2 mmoles) of diethoxymagnesium, 135 mL of toluene, and 9.2 mL (39.5 mmoles) of di-n-propyl phthalate was charged into the above-prepared mixed solution with keeping the liquid temperature thereof at −10° C.
(iii) The above initial contact product-containing solution was set to the temperature of 110° C. and the reaction was carried out for 180 minutes while keeping this temperature. After completion of the reaction, the supernatant solution was withdrawn, and the first contact product, i.e., the reaction product, was washed with 250 mL of toluene at 100° C. four times.
(iv) Next, to the resulting first contact product, 185 mL of toluene and 30 mL (272.0 mmoles) of titanium tetrachloride were added; then, the temperature of the resulting mixture was raised to 110° C., at which temperature the reaction was carried out for 120 minutes to obtain the final contact product.

Next, the resulting final contact product was washed with 188 mL of n-heptane at 40° C. eight times, then by conducting the solid-liquid separation, the solid catalyst component ((2) the solid catalyst component for olefin polymerization containing the phthalate diester) was obtained.

The contents of titanium and of the phthalate diester compound in the solid portion obtained by the solid-liquid separation of (2) the solid catalyst component obtained were measured to be 2.5% by mass and 12.2% by mass, respectively.

### (Production Example 3) Synthesis of (3) Solid Catalyst Component for Olefin Polymerization Containing Succinate Diester Compound and Phthalate Diester Compound

By using, as the internal electron-donating compounds, diethyl diisopropylsuccinate as the succinate diester compound and di-n-butyl phthalate as the phthalate diester compound, the solid catalyst component for olefin polymerization was prepared by the method described below.
(i) Into a 500-mL flask equipped with a stirrer and completely purged with a nitrogen gas inside thereof, 20 mL (182.4 mmoles) of titanium tetrachloride and 40 mL of toluene were charged to form a mixed solution.
(ii) Next, a suspension solution obtained from 10.0 g (87.2 mmoles) of diethoxymagnesium, 45 mL of toluene, and 2.4 mL (9.0 mmoles) of di-n-butyl phthalate was charged into the above-prepared mixed solution with keeping the liquid temperature thereof at −6° C.
(iii) The temperature of the resulting initial contact product-containing solution was raised, and at 60° C. in the midway of the temperature raising, 1.2 mL (2.2 mmoles) of diethyl diisopropylsuccinate was added to the solution. After the temperature was further raised to 100° C., the reaction was carried out for 90 minutes while keeping this temperature. After completion of the reaction, the supernatant solution was withdrawn, and the first contact product, i.e., the reaction product, was washed with 85 mL of toluene at 100° C. four times.
(iv) Next, to the resulting first contact product, 84 mL of toluene and 16 mL (145.6 mmoles) of titanium tetrachloride were added; then, the temperature of the resulting mixture was raised to 110° C., at which temperature the reaction was carried out for 120 minutes. After completion of the reaction, the operation to withdraw the supernatant solution was repeated three times to obtain the final contact product.

Next, the resulting final contact product was washed with 70 mL of n-heptane at 40° C. eight times, then by conducting the solid-liquid separation, the solid catalyst component ((3) the solid catalyst component for olefin polymerization containing the succinate diester compound and the phthalate diester compound) was obtained.

The contents of titanium, of the dibutyl phthalate, and of the succinate diester compound (ID) in the solid portion obtained by the solid-liquid separation of (3) the solid catalyst component obtained were measured to be 1.81% by mass, 12.9% by mass, and 4.3% by mass, respectively.

### Example 1

### <Preparation of Ethylene-Propylene Copolymerization Catalyst>

(1) The solid catalyst component for olefin polymerization containing the succinate diester compound and (2) the solid catalyst component for olefin polymerization containing the phthalate diester compound were taken into a heat-resistant glass bottle with the weight ratio of 10:90, and then, they were mixed by shaking to obtain a mixture of the solid catalyst components.

Also, after tetraethoxysilane and diethylaminotriethoxysilane were taken into a heat-resistant glass bottle having a stirrer tip therein with the mass ratio (Y/X)=33/67 (=molar ratio of 30:70), the resulting mixture was stirred and mixed using a magnetic stirrer and then diluted with n-heptane to obtain the external donor mixture.

Next, 2.2 mmoles of triethylaluminum, a total of 0.22 mmoles of the above-obtained external donor mixture in terms of silicon atom, and a total of 10.9 mg (0.0055 mmoles in terms of titanium atom) of the afore-mentioned solid catalyst component mixture were charged into an autoclave with an inner volume of 2.0 liters equipped with a stirrer and completely purged with a nitrogen gas to prepare the ethylene-propylene Copolymerization Catalyst.

### <Ethylene-Propylene Copolymerization>

Into the autoclave equipped with a stirrer containing the above-prepared ethylene-propylene Copolymerization Catalyst, 15 moles of liquefied propylene (1.2 liters) and 0.20 MPa of a hydrogen gas (partial pressure) were charged. After prepolymerization was carried out at 20° C. for 5 minutes, the temperature was raised, and the first-stage propylene homo-polymerization reaction (homo-stage polymerization) was carried out at 70° C. for 45 minutes. After the pressure was resumed to a normal pressure and the inside the autoclave (inside the reactor) was purged with a nitrogen gas, the autoclave was weighed; then, the weight of the empty autoclave was subtracted from this weight to calculate the homo-stage (first stage) polymerization activity (homo-activity, g-PP/g-cat).

Some of the polymer produced were taken for evaluation of the polymerization performance and of physical properties of the polymer.

Next, ethylene/propylene were charged into the autoclave (into the reactor) with the molar ratio of 1.5/1.0, then after the temperature was raised to 70° C., the reaction was carried out at 1.2 MPa and 70° C. with charging ethylene/propylene/hydrogen into the autoclave at the gas supply rate per one minute (liter/min) of 1.6/2.4/0.09 to obtain the ethylene-propylene copolymer.

### <Polymerization Activity Per 1 Gram of Solid Catalyst Component>

The polymerization activity per 1 gram of the solid catalyst component was determined from the following formula (12):

$$Polymerization activity ( g / g - cat ) = mass of polymer ( g ) / mass of solid catalyst component ( g ) \qquad ( 12 )$$

### <Melt Flow Rate (MFR)>

The melt flow rate (MFR) of the olefin polymer was measured by the method in accordance with ASTM D 1238 and JIS K 7210.

### <Block Ratio (% by Mass)>

The block ratio of ethylene-propylene copolymer was calculated using the following formula (13):

$$Block ratio ( \% by mass ) = \{ ( I ( g ) - G ( g ) ) / ( I ( g ) - F ( g ) ) \} \times 100 \qquad ( 13 )$$

In the formula, I is the autoclave mass (g) after the copolymerization reaction is completed, G is the autoclave mass (g) after the homo-polymerization of propylene is completed and unreacted monomer is removed, and F is the autoclave mass (g).

### <Flexural Modulus (FM)>

The injection-molded test piece of the olefin polymer having the thickness of 4.0 mm, the width of 10.0 mm, and the length of 170.0 mm was prepared at the molding temperature of 180° C. and the die temperature of 40° C. using NEX-III-3EG manufactured by Nissei Plastic Industrial Co., Ltd., and the flexural modulus (FM) of the olefin polymer was measured at the atmospheric temperature of 23° C. by the method in accordance with JIS K7171 (unit: MPa).

### <Impact Resistance (IZOD)>

The impact resistance (IZOD) of the olefin polymer was measured by the method in accordance with JIS K 7110 (“Method of Izod Impact Test For Rigid Plastics”) (unit: KJ/m2).

First, 0.10% by weight of IRGANOX 1010 (manufactured by BASF GmbH) and 0.10% by weight of IRGAFOS 168 (manufactured by BASF GmbH) were added to the ethylene-propylene copolymer, and the resulting mixture was kneaded and granulated in a biaxial kneader to obtain ethylene-propylene copolymer pellets. The resulting ethylene-propylene copolymer pellets were charged into an injection molding machine (the die temperature of 40° C. and the cylinder temperature of 180° C.) to carry out the injection molding to obtain a test piece for measurement of the properties thereof. The resulting test piece was cut out to make a specimen, which was then processed as described below. After this was allowed to be conditioned in a temperature-controlled chamber maintained at 23° C. for at least 72 hours, the Izod impact strength of the specimen was measured using an impact tester No. 258-L (equipped with a low-temperature chamber) manufactured by Yasuda Seiki Seisakusho, Ltd.
Shape of specimen: ISO 180/1A, thickness of 4.0 mm, width of 8.0 mm, and length of 80.0 mm
Shape of notch: A-type notch (radius: 0.25 mm) formed by using a die equipped with a notch.
Temperature: 23° C.
Impact velocity: 3.5 m/sec
Nominal pendulum energy: 2.75 J (23° C.)

### Example 2

Preparation of the ethylene-propylene Copolymerization Catalyst and ethylene-propylene copolymerization were carried out in the same way as in Example 1 to obtain an ethylene-propylene copolymer, except that as the external donor, the external donor mixture obtained by mixing tetraethoxysilane and diethylaminotriethoxysilane with the mass ratio (Y/X)=47/53 (=molar ratio 50:50) with the amount of 0.22 mmoles in terms of silicon atom was used.

### Comparative Example 1

Preparation of the ethylene-propylene Copolymerization Catalyst and ethylene-propylene copolymerization were carried out in the same way as in Example 1 to obtain an ethylene-propylene copolymer, except that as the solid catalyst component, (1) the solid catalyst component for olefin polymerization containing the succinate diester compound was not used, but only (2) the solid catalyst component for olefin polymerization containing the phthalate diester compound with the amount of 0.0055 mmoles in terms of titanium atom was used.

### Comparative Example 2

Preparation of the ethylene-propylene Copolymerization Catalyst and ethylene-propylene copolymerization were carried out in the same way as in Example 1 to obtain an ethylene-propylene copolymer, except that as the external donor, tetraethoxysilane was not used, but only diethylaminotriethoxysilane with the amount of 0.22 mmoles in terms of silicon atom was used.

### Comparative Example 3

Preparation of the ethylene-propylene Copolymerization Catalyst and ethylene-propylene copolymerization were carried out in the same way as in Example 1 to obtain an ethylene-propylene copolymer, except that as the solid catalyst component, (1) the solid catalyst component for olefin polymerization containing the succinate diester compound was not used, but only (2) the solid catalyst component for olefin polymerization containing the phthalate diester compound with the amount of 0.0055 mmoles in terms of titanium atom was used, and that as the external donor, the external donor mixture obtained by mixing tetraethoxysilane and diethylaminotriethoxysilane with the mass ratio (Y/X)=47/53 (=molar ratio 50:50) with the amount of 0.22 mmoles in terms of silicon atom was used.

TABLE 1

| | Homo activity | Homo MFR | ICP activity | ICP MFR | Block ratio | FM | IZOD |
|---|---|---|---|---|---|---|---|
| | (g-PP/g-cat) | (g/10 min) | (g-ICP/g-cat) | (g/10 min) | (% by mass) | (MPa) | (kJ/m²) |
| Example 1 | 29100 | 210 | 11900 | 26 | 29 | 1170 | 19 |
| Example 2 | 28200 | 160 | 11600 | 18 | 29 | 1100 | 45 |
| Comparative | 25900 | 230 | 9700 | 32 | 27 | 980 | 17 |
| Example 1 | | | | | | | |
| Comparative | 31100 | 89 | 13300 | 14 | 30 | 1070 | 47 |
| Example 2 | | | | | | | |
| Comparative | 29800 | 150 | 13100 | 22 | 30 | 970 | 46 |
| Example 3 | | | | | | | |

### INDUSTRIAL APPLICABILITY

According to the present invention, an olefin polymer having an excellent melt flowability with a small use amount of hydrogen and a high flexural modulus may be produced.

1. An olefin polymerization catalyst comprising:
(I) a solid catalyst component for olefin polymerization containing at least magnesium, titanium, halogen, and an internal electron-donating compound,
(II) an organoaluminum compound; and
(III) an external electron-donating compound,
wherein
in the olefin polymerization catalyst, there exist, as the internal electron-donating compound, a first internal electron-donating compound and a second internal electron-donating compound; the first internal electron-donating compound being one or more compounds selected from a succinate diester compound, and the second internal electron-donating compound being one or more compounds selected from an internal electron-donating compound other than the succinate diester compound; and further comprises as the external electron-donating compound at least one or more compounds selected from alkoxysilane compounds represented by the following general formula (1): 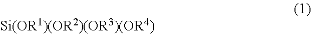
in the formula, R¹, R², R³, and R⁴, all of which are optionally identical or different from each other, represent a linear alkyl group having the carbon number of 1 to 8, or a branched alkyl group having the carbon number of 3 to 8, and
one or more compounds selected from aminoalkoxysilane compounds represented by the following general formula (2): 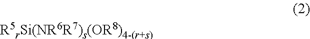
in the formula, r is 0 to 2, s is 1 to 3, and r+s is 1 to 3, R⁵, which optionally contains a heteroatom, represents any group selected from a linear or a branched alkyl group having the carbon number of 1 to 12, a substituted or an unsubstituted cycloalkyl group, a phenyl group, an allyl group, and an aralkyl group, R⁶ and R⁷, which are optionally identical or different from each other and optionally contain a heteroatom, represent a hydrogen atom or any group selected from a linear or a branched alkyl group having the carbon number of 1 to 12, a substituted or an unsubstituted cycloalkyl group, a phenyl group, an allyl group, and an aralkyl group, R⁶ and R⁷ are optionally combined to form a ring shape, and R⁶ and R⁷ are optionally identical or different from each other, R⁸, which optionally contains a heteroatom, represents any group selected from an alkyl group having the carbon number of 1 to 12, a cycloalkyl group, a phenyl group, a vinyl group, an allyl group, and an aralkyl group, and when R⁸ is plural, they are optionally identical or different from each other.

2. The olefin polymerization catalyst according to claim 1, the catalyst comprising:
as (I) the solid catalyst component for olefin polymerization, (a1) a first internal electron-donating compound-containing solid catalyst component for olefin polymerization containing magnesium, titanium, halogen, and the first internal electron-donating compound as the internal electron-donating compound and (a2) a second internal electron-donating compound-containing solid catalyst component for olefin polymerization containing magnesium, titanium, halogen, and the second internal electron-donating compound as the internal electron-donating compound; and
as (III) the external electron-donating compound, the alkoxysilane compound represented by the general formula (1) and the aminoalkoxysilane compound represented by the general formula (2).

3. The olefin polymerization catalyst according to claim 1, the catalyst comprising:
as (I) the solid catalyst component for olefin polymerization, (b) a first internal electron-donating compound- and a second internal electron-donating compound-containing solid catalyst component for olefin polymerization containing magnesium, titanium, halogen, and as the internal electron-donating compound, the first internal electron-donating compound and the second internal electron-donating compound, and
as (III) the external electron-donating compound, the alkoxysilane compound represented by the general formula (1) and the aminoalkoxysilane compound represented by the general formula (2).

4. The olefin polymerization catalyst according to claim 1, wherein the alkoxysilane compound represented by the general formula (1) is at least one selected from the group consisting of tetramethoxysilane, tetraethoxysilane, tetra(n-propoxy)silane, tetraisopropoxysilane, tetra(n-butoxy)silane, tetraisobutoxysilane, and tetrakis(2-ethylhexyloxy)silane.

5. The olefin polymerization catalyst according to claim 1, wherein the aminoalkoxysilane compound represented by the general formula (2) is at least one from the group consisting of dimethylaminotriethoxysilane, diethylaminotrimethoxysilane, diethylaminotriethoxysilane, diethylaminotri-n-propoxysilane, di-n-propylaminotriethoxysilane, methyl-n-propylaminotriethoxysilane, methyl-t-butylaminotriethoxysilane, ethyl-n-propylaminotriethoxysilane, ethylisopropylaminotriethoxysilane, and methylethylaminotriethoxysilane.

6. The olefin polymerization catalyst according to claim 1, wherein a molar ratio (Y/X) of a mole content (Y) of the aminoalkoxysilane compound represented by the general formula (2) to a mole content (X) of the alkoxysilane compound represented by the general formula (1) is from 1/99 to 70/30.

7. A method for producing an olefin polymer, the method comprising polymerizing an olefin using the olefin polymerization catalyst according to claim 1.
